(19) United States
(12) Patent Application Publication
(10) Pub. No.: US 2025/0088929 A1
(43) Pub. Date: Mar. 13, 2025

(54) NETWORK ENERGY SAVINGS IN TERRESTRIAL AND NON-TERRESTRIAL NETWORK COEXISTENCE DEPLOYMENT

(71) Applicant: QUALCOMM Incorporated, San Diego, CA (US)

(72) Inventor: Mohamad SAYED HASSAN, Paris (FR)

(21) Appl. No.: 18/466,742

(22) Filed: Sep. 13, 2023

(51) Int. Cl. H04W 36/08; H04W 36/00; H04W 52/02

(52) U.S. Cl. CPC H04W 36/083; H04W 36/0058; H04W 52/0206

(57) ABSTRACT

Methods, systems, and devices for wireless communication are described. A network entity (e.g., terrestrial network entity) may transmit a handover request to a user equipment (UE) indicating that an non-terrestrial network (NTN) entity is available for providing services to the UE based at least in part on a network energy saving (NES) mode of the network entity. The handover request may also indicate a time duration to the UE, where the time duration is based on the NES mode and an NTN service availability duration of the NTN entity, and the UE may establish a connection with the NTN entity during the time duration. The UE may monitor for synchronization signal blocks (SSBs) from the NTN entity (e.g., instead of the network entity) based on an indication of the terrestrial network entity.

### FIELD OF TECHNOLOGY

The following relates to wireless communication, including network energy savings in terrestrial and non-terrestrial network coexistence deployment.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may communicate with entities from a terrestrial network (TN) (e.g., network entities, terrestrial network entities) and entities from a non-terrestrial network (NTN) (e.g., NTN entities). Additionally, a network entity may enter a network energy saving (NES) mode, where transmission and reception may be limited in order to save energy at the network entity.

### SUMMARY

The described techniques relate to improved methods, systems, devices, and apparatuses that support network energy savings in terrestrial and non-terrestrial network (NTN) coexistence deployment. For example, the described techniques provide for a network entity that is part of a terrestrial network (TN) (e.g., a network entity, a terrestrial network entity) to indicate information to a UE indicating a non-terrestrial network entity (e.g., a satellite) that may be available for providing services to the UE, and indicating information related to a network energy saving (NES) mode for the network entity. In some cases, TN and NTN coexistence (e.g., coexistence deployment) may refer to a TN and an NTN serving a same geographical area via a same frequency band, via respective frequency bands that are at least partially overlapping, different frequency bands, or any combination thereof.

According to a first proposal, the network entity may indicate, to a UE (e.g., a UE in an RRC_CONNECTED mode), that an NTN entity is available for providing services to the UE, and may indicate a time duration (e.g., a timer). The UE may establish a connection with the NTN entity during the time duration, and the UE may refrain from connecting with the network entity during the time duration. That is, the duration may limit the ability of the UE to reconnect with the network entity, thereby limiting the power saving impact of the NES mode for the network entity. In some cases, the time duration may be based on a duration of the NES mode (e.g., an NES duration), an NTN service availability duration, or both.

According to a second proposal, the network entity may signal (e.g., using various techniques) to a UE (e.g., a UE in an IDLE mode) an indication of the NTN entity for the UE to monitor during the NES duration. In some cases, the network entity may transmit the indications of the NTN and the information related to the NES to the UE based at least in part on a traffic demand satisfying a threshold (e.g., being below a threshold), and based at least in part on the NTN entity offering one or more services requested by the UE.

According to both the first proposal and the second proposal, the network entities may communicate information with the NTN entities to support these proposals. For example, the information may include services provided by the NTN entity, positional data (e.g., ephemeris), satellite type, UE information (e.g., requested services, positional data), or any combination thereof.

A method for wireless communication by a UE is described. The method may include receiving, from a TN entity, a handover request including information that indicates a NTN entity and a time duration during which the UE is to refrain from reconnecting with the TN entity and establishing a communication link with the NTN entity based on the handover request.

A UE for wireless communication is described. The UE may include one or more processors, one or more memories coupled with the one or more processors, and one or more processor-readable instructions stored in the one or more memories. The one or more processors may individually or collectively execute the instructions to cause the UE (e.g., an apparatus at the UE) to receive, from a TN entity, a handover request including information that indicates a NTN entity and a time duration during which the UE is to refrain from reconnecting with the TN entity and establish a communication link with the NTN entity based on the handover request.

Another UE for wireless communication is described. The UE may include means for receiving, from a TN entity, a handover request including information that indicates a NTN entity and a time duration during which the UE is to refrain from reconnecting with the TN entity and means for establishing a communication link with the NTN entity based on the handover request.

A non-transitory computer-readable medium storing code for wireless communication is described. The code may include instructions executable by a processor to receive, from a TN entity, a handover request including information that indicates a NTN entity and a time duration during which the UE is to refrain from reconnecting with the TN entity and establish a communication link with the NTN entity based on the handover request.

Some examples of the method, UEs, and non-transitory computer-readable medium described herein may further include operations, features, means, or instructions for communicating with the NTN entity over the communication link during the time duration.

In some examples of the method, UEs, and non-transitory computer-readable medium described herein, the time duration may be based on a service availability duration associated with the NTN entity, a NES duration associated with the TN entity, or both the service availability duration and the NES duration.

In some examples of the method, UEs, and non-transitory computer-readable medium described herein, the information indicates a start slot and an end slot corresponding to the time duration.

Some examples of the method, UEs, and non-transitory computer-readable medium described herein may further include operations, features, means, or instructions for transmitting second information that indicates a set of communication services used for communications by the UE, where receiving the handover request includes receiving the handover request based on the set of communication services.

In some examples of the method, UEs, and non-transitory computer-readable medium described herein, the set of communication services includes a data rate, service type, a communication priority, or a combination thereof and receiving the handover request includes receiving the handover request based on the NTN entity supporting one or more of the set of communication services.

In some examples of the method, UEs, and non-transitory computer-readable medium described herein, the information indicates that the handover request may be configured to offload one or more UEs including the UE to the NTN entity.

Some examples of the method, UEs, and non-transitory computer-readable medium described herein may further include operations, features, means, or instructions for receiving a request to measure one or more signals transmitted by the NTN entity and transmitting a measurement report that indicates a result of measurements of the one or more signals transmitted by the NTN entity, where receiving the handover request includes receiving the handover request based on the measurement report.

In some examples of the method, UEs, and non-transitory computer-readable medium described herein, a duration of a discontinuous reception cycle, a discontinuous transmission cycle, or both, for the TN entity, may be based on a service duration associated with the NTN entity.

Some examples of the method, UEs, and non-transitory computer-readable medium described herein may further include operations, features, means, or instructions for receiving, during a communication duration of a NES mode for the TN entity, an instruction to reset the time duration.

A method for wireless communication by a TN entity is described. The method may include communicating, with a NTN entity, first information associated with a handover of one or more UEs serviced by the TN entity and transmitting, to a first UE of the one or more UEs, a handover request including second information that indicates the NTN entity and a time duration during which the first UE is to refrain from reconnecting with the TN entity.

A TN entity for wireless communication is described. The TN entity may include one or more processors, one or more memories coupled with the one or more processors, and one or more processor-readable instructions stored in the one or more memories. The one or more processors may individually or collectively execute the instructions to cause the TN entity (e.g., an apparatus at the TN entity) to communicate, with a NTN entity, first information associate with a handover of one or more UEs serviced by the TN entity and transmit, to a first UE of the one or more UEs, a handover request including second information that indicates the NTN entity and a time duration during which the first UE is to refrain from reconnecting with the TN entity.

Another TN entity for wireless communication is described. The TN entity may include means for communicating, with a NTN entity, first information associated with a handover of one or more UEs serviced by the TN entity and means for transmitting, to a first UE of the one or more UEs, a handover request including second information that indicates the NTN entity and a time duration during which the first UE is to refrain from reconnecting with the TN entity.

A non-transitory computer-readable medium storing code for wireless communication is described. The code may include instructions executable by a processor to communicate, with a NTN entity, first information associate with a handover of one or more UEs serviced by the TN entity and transmit, to a first UE of the one or more UEs, a handover request including second information that indicates the NTN entity and a time duration during which the first UE is to refrain from reconnecting with the TN entity.

In some examples of the method, TN entities, and non-transitory computer-readable medium described herein, the time duration may be based on a service availability duration associated with the NTN entity, a NES duration associated with the TN entity, or both the service availability duration and the NES duration.

In some examples of the method, TN entities, and non-transitory computer-readable medium described herein, the second information indicates a start slot and an end slot corresponding to the time duration.

In some examples of the method, TN entities, and non-transitory computer-readable medium described herein, communicating the first information may include operations, features, means, or instructions for receiving the first information that indicates a service availability duration for communications between the first UE and the NTN entity, where the time duration may be based on the service availability duration.

In some examples of the method, TN entities, and non-transitory computer-readable medium described herein, the time duration may be further based on a propagation delay of communications between the NTN entity and the first UE.

Some examples of the method, TN entities, and non-transitory computer-readable medium described herein may further include operations, features, means, or instructions for transmitting, during a communication duration of a NES mode for the TN entity, an instruction to reset the time duration, where the TN entity may be configured to enter a discontinuous reception cycle, a discontinuous transmission cycle, or both during the time duration.

Some examples of the method, TN entities, and non-transitory computer-readable medium described herein may further include operations, features, means, or instructions for receiving, from the first UE, third information that indicates set of communication services used for communications by the first UE, where transmitting the handover request includes transmitting the handover request based on the set of communication services.

In some examples of the method, TN entities, and non-transitory computer-readable medium described herein, the set of communication services includes a data rate, service type, a communication priority, or a combination thereof and transmitting the handover request includes transmitting the handover request based on receiving, from the NTN entity, an indication that one or more of the set of communication services may be supported by the NTN entity.

In some examples of the method, TN entities, and non-transitory computer-readable medium described herein, transmitting the handover request may include operations, features, means, or instructions for transmitting the handover request based on a traffic demand from the one or more UEs serviced by the TN entity satisfying a threshold.

Some examples of the method, TN entities, and non-transitory computer-readable medium described herein may further include operations, features, means, or instructions for transmitting a request to measure one or more signals transmitted by the NTN entity and receiving a measurement report that indicates a result of measurements of the one or more signals transmitted by the NTN entity, where transmitting the handover request transmitting the handover request based on the measurement report.

In some examples of the method, TN entities, and non-transitory computer-readable medium described herein, communicating the first information may include operations, features, means, or instructions for communicating the first information that indicates attributes associated with the NTN entity, one or more communication service parameters for UEs serviced by the TN entity, a traffic load for the TN entity, one or more cell energy saving mode configurations, or a combination thereof, where transmitting the handover request includes transmitting the handover request based on the first information.

A method for wireless communication by a UE is described. The method may include monitoring for one or more SSBs transmitted by a TN entity and receiving, based on the monitoring, information that indicates that a NTN entity is available for communications during a NES duration for the TN entity.

A UE for wireless communication is described. The UE may include one or more processors, one or more memories coupled with the one or more processors, and one or more processor-readable instructions stored in the one or more memories. The one or more processors may individually or collectively execute the instructions to cause the UE (e.g., an apparatus at the UE) to monitor for one or more SSBs transmitted by a TN entity and receive, based on the monitoring, information that indicates that a NTN entity is available for communications during a NES duration for the TN entity.

Another UE for wireless communication is described. The UE may include means for monitoring for one or more SSBs transmitted by a TN entity and means for receiving, based on the monitoring, information that indicates that a NTN entity is available for communications during a NES duration for the TN entity.

A non-transitory computer-readable medium storing code for wireless communication is described. The code may include instructions executable by a processor to monitor for one or more SSBs transmitted by a TN entity and receive, based on the monitoring, information that indicates that a NTN entity is available for communications during a NES duration for the TN entity.

Some examples of the method, UEs, and non-transitory computer-readable medium described herein may further include operations, features, means, or instructions for communicating with the NTN entity based on the information.

In some examples of the method, UEs, and non-transitory computer-readable medium described herein, receiving the information may include operations, features, means, or instructions for receiving, in a system information update, an information element including the information that indicates that the NTN entity may be available.

In some examples of the method, UEs, and non-transitory computer-readable medium described herein, receiving the information may include operations, features, means, or instructions for receiving the one or more SSBs in accordance with a configuration that indicates that the NTN entity may be available.

In some examples of the method, UEs, and non-transitory computer-readable medium described herein, the configuration includes at least one of a time offset associated with receiving the one or more SSBs, a periodicity of receipt of the one or more SSBs, a resource in which the one or more SSBs may be received, a pattern of receiving the one or more SSBs, or a combination thereof.

In some examples of the method, UEs, and non-transitory computer-readable medium described herein, receiving the information may include operations, features, means, or instructions for receiving control signaling that indicates at least one attribute of the NTN entity, where the at least one attribute indicates that the NTN entity may be available.

In some examples of the method, UEs, and non-transitory computer-readable medium described herein, the at least one attribute of the NTN entity includes a NTN availability flag, an ephemeris associated with the NTN entity, or both.

A method for wireless communication by a TN entity is described. The method may include communicating, with a NTN entity, first information associated with communications between the NTN entity and one or more UEs and transmitting, to a first UE based on the first information, second information that indicates that the NTN entity is available for communications during a NES duration for the TN entity.

A TN entity for wireless communication is described. The TN entity may include one or more processors, one or more memories coupled with the one or more processors, and one or more processor-readable instructions stored in the one or more memories. The one or more processors may individually or collectively execute the instructions to cause the TN entity (e.g., an apparatus at the TN entity) to communicate, with a NTN entity, first information associate with communications between the NTN entity and one or more UEs and transmit, to a first UE based on the first information, second information that indicates that the NTN entity is available for communications during a NES duration for the TN entity.

Another TN entity for wireless communication is described. The TN entity may include means for communicating, with a NTN entity, first information associated with communications between the NTN entity and one or more UEs and means for transmitting, to a first UE based on the first information, second information that indicates that the NTN entity is available for communications during a NES duration for the TN entity.

A non-transitory computer-readable medium storing code for wireless communication is described. The code may include instructions executable by a processor to communicate, with a NTN entity, first information associate with communications between the NTN entity and one or more UEs and transmit, to a first UE based on the first information, second information that indicates that the NTN entity is available for communications during a NES duration for the TN entity.

In some examples of the method, TN entities, and non-transitory computer-readable medium described herein, transmitting the second information may include operations, features, means, or instructions for transmitting, in a system information update, an information element including the first information that indicates that the NTN entity may be available.

In some examples of the method, TN entities, and non-transitory computer-readable medium described herein, transmitting the second information may include operations, features, means, or instructions for transmitting one or more SSBs in accordance with a configuration that indicates that the NTN entity may be available.

In some examples of the method, TN entities, and non-transitory computer-readable medium described herein, the configuration includes at least one of a time offset associated with receiving the one or more SSBs, a periodicity of receipt of the one or more SSBs, a resource in which the one or more SSBs may be received, a pattern of receiving the one or more SSBs, or a combination thereof.

In some examples of the method, TN entities, and non-transitory computer-readable medium described herein, transmitting the second information may include operations, features, means, or instructions for transmitting control signaling that indicates at least one attribute of the NTN entity, where the at least one attribute indicates that the NTN entity may be available.

In some examples of the method, TN entities, and non-transitory computer-readable medium described herein, the at least one attribute of the NTN entity includes a NTN availability flag, an ephemeris associated with the NTN entity, or both.

In some examples of the method, TN entities, and non-transitory computer-readable medium described herein, transmitting the second information may include operations, features, means, or instructions for transmitting the second information based on a set of communication services offered by the NTN entity including a communication service requested by the first UE.

Some examples of the method, TN entities, and non-transitory computer-readable medium described herein may further include operations, features, means, or instructions for transitioning from a communication mode to a NES mode during the NES duration.

### BRIEF DESCRIPTION OF THE DRAWINGS

FIG. 1 shows an example of a wireless communications system that supports network energy savings in terrestrial and non-terrestrial network (NTN) coexistence deployment in accordance with one or more aspects of the present disclosure.

FIG. 2 shows an example of a network architecture that supports network energy savings in terrestrial and NTN coexistence deployment in accordance with one or more aspects of the present disclosure.

FIG. 3 shows an example of a wireless communications system that supports network energy savings in terrestrial and NTN coexistence deployment in accordance with one or more aspects of the present disclosure.

FIG. 4 shows an example of a timing diagram that supports network energy savings in terrestrial and NTN coexistence deployment in accordance with one or more aspects of the present disclosure.

FIG. 5 shows an example of a process flow that supports network energy savings in terrestrial and NTN coexistence deployment in accordance with one or more aspects of the present disclosure.

FIG. 6 shows an example of a process flow that supports network energy savings in terrestrial and NTN coexistence deployment in accordance with one or more aspects of the present disclosure.

FIGS. 7 and 8 show block diagrams of devices that support network energy savings in terrestrial and NTN coexistence deployment in accordance with one or more aspects of the present disclosure.

FIG. 9 shows a block diagram of a communications manager that supports network energy savings in terrestrial and NTN coexistence deployment in accordance with one or more aspects of the present disclosure.

FIG. 10 shows a diagram of a system including a device that supports network energy savings in terrestrial and NTN coexistence deployment in accordance with one or more aspects of the present disclosure.

FIGS. 11 and 12 show block diagrams of devices that support network energy savings in terrestrial and NTN coexistence deployment in accordance with one or more aspects of the present disclosure.

FIG. 13 shows a block diagram of a communications manager that supports network energy savings in terrestrial and NTN coexistence deployment in accordance with one or more aspects of the present disclosure.

FIG. 14 shows a diagram of a system including a device that supports network energy savings in terrestrial and NTN coexistence deployment in accordance with one or more aspects of the present disclosure.

FIGS. 15 through 24 show flowcharts illustrating methods that support network energy savings in terrestrial and NTN coexistence deployment in accordance with one or more aspects of the present disclosure.

### DETAILED DESCRIPTION

In some cases, a user equipment (UE) may communicate with an entity that is part of a terrestrial network (TN) (e.g., a network entity, a terrestrial network entity) or with an entity that is part of a non-terrestrial network (NTN) (e.g., an NTN entity, a satellite that is part of an NTN). For example, the UE may communicate with the TN entity, the NTN entity, or both, due to a TN and NTN coexistence deployment. A TN and NTN coexistence deployment may refer to a TN and an NTN serving a same geographical area via a same frequency band, via respective frequency bands that are at least partially overlapping, via different frequency bands, or any combination thereof. Also, the network entity may enter a network energy saving (NES) mode (e.g., discontinuous transmission (DTX) off duration, NES duration), which may include providing limited services to the UE to support energy savings at the network entity. For example, during the NES mode, the network entity may refrain from transmitting one or more synchronization signal blocks (SSBs) or may limit transmission periodicity of SSB transmission.

In some cases, a UE (e.g., a UE that is in an IDLE mode) may attempt to establish a connection with the network entity during the NES mode, which may cause the network entity to wake up and reduce the power saving effect of the NES mode. Additionally, or alternatively, a coverage area of an NTN entity may overlap with the coverage area of a TN entity, and a UE (e.g., a UE that is in an RRC_CONNECTED mode) may connect with the NTN entity (e.g., during the NES mode). However, the UE may switch back and forth rapidly (e.g., ping pong) between the NTN entity and the network entity because of the detected service of the network entity, reducing the effect of the NES mode.

According to techniques described herein, a network entity that is part of a TN (e.g., a network entity, a terrestrial network entity) may indicate information to a UE indicating an NTN entity (e.g., a satellite) that may be available for providing services to the UE, and indicating information related to an NES mode for the network entity.

According to a first proposal, the network entity may indicate, to a UE (e.g., a UE in an RRC_CONNECTED mode), that an NTN entity is available for providing services to the UE, and may indicate a time duration (e.g., a timer). The UE may establish a connection with the NTN entity during the time duration, and the UE may refrain from connecting with the network entity during the time duration. That is, the duration may limit the ability of the UE to reconnect with the network entity, thereby improving the power savings of the NES mode for the network entity. In some cases, the time duration may be based on a duration of the NES mode (e.g., an NES duration), an NTN service availability duration, or both.

According to a second proposal, the network entity may signal (e.g., using various techniques) to a UE (e.g., a UE in an IDLE mode) an indication of the NTN entity for the UE to monitor during the NES duration. In some cases, the network entity may transmit the indications of the NTN and the information related to the NES to the UE based at least in part on a traffic demand satisfying a threshold (e.g., being below a threshold), and based at least in part on the NTN entity offering one or more services requested by the UE. As described in further detail herein, various types of signaling may be used to indicate the NTN entity availability.

According to both the first proposal and the second proposal, the network entities (e.g., terrestrial network entities) may communicate information with the NTN entities to support these proposals. For example, the information may include services provided by the NTN entity, positional data (e.g., ephemeris), satellite type, UE information (e.g., requested services, positional data), or any combination thereof.

Aspects of the disclosure are initially described in the context of wireless communications systems. Aspects of the disclosure are also described in the context of timing diagrams and process flows. Aspects of the disclosure are further illustrated by and described with reference to apparatus diagrams, system diagrams, and flowcharts that relate to network energy savings in terrestrial and NTN coexistence deployment.

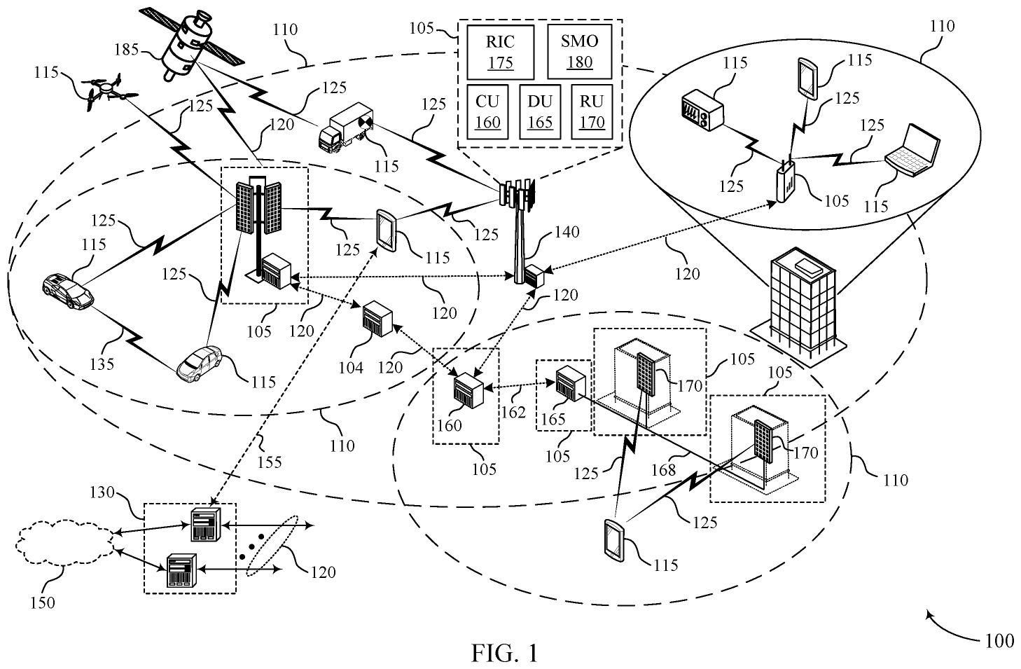

FIG. 1 shows an example of a wireless communications system 100 that supports network energy savings in terrestrial and NTN coexistence deployment in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support network energy savings in terrestrial and NTN coexistence deployment as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Additionally, communications links, such as communication links 125, may include downlink transmissions from an NTN entity 185 to a UE 115, and uplink transmissions from a UE 115 to the NTN entity 185. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 and an NTN entity 185 may each provide communication coverage via one or more cells, for example a macro cell, a small cell, a hot spot, or other types of cells, or any combination thereof. The term “cell” may refer to a logical communication entity used for communication with an entity (e.g., a network entity 105, a NTN entity 185, using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105 and the NTN entity 185. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. Macro cells may be associated with NTN entities 185. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140), NTN entities 185, or both, may have similar frame timings, and transmissions from different network entities 105 and NTN entities 185 may be approximately aligned in time. For asynchronous operation, network entities 105, NTN entities 185, or both, may have different frame timings, and transmissions from different network entities 105 and NTN entities 185 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Devices of the wireless communications system 100 may perform various techniques to support energy savings. For example, the network entities 105 may implement network energy savings (NES) modes, where the network entities 105 offer limited services while in the NES mode. If UE is in a cell supported by a network entity that is entering a NES mode, the wireless communications or coverage for the UE may be impacted.

In some cases, the NTN entity 185 may represent a satellite or other entity that is part of an NTN. The NTN entity 185 may communicate with the UEs 115, the network entities 105, other entities of the wireless communications system 100, or any combination thereof, through any or all communication techniques described herein (e.g., beamforming, MU-MIMO). Additionally, the NTN entity 185 may be associated with a cell (e.g., serving cell) that may encompass one or more network entities 105, and may move with the NTN entity 185. For example, the NTN entity 185 may move in an orbit or pattern around the Earth, and a cell of the NTN entity 185 may move with the NTN entity, providing coverage to UEs 115 that are within the cell. Thus, if the NTN entity 185 is providing coverage that overlaps with a network entity 105, then the network entity 105 may be able to enter a NES mode while limiting impact of wireless communication coverage for one or more UEs 115 within the coverage area supported by the network entity 105. That is, the UEs 115 may communicate with the NTN entity 185 while the network entity 105 is in the energy saving mode.

To support these techniques, a network entity that is part of a terrestrial network (TN) (e.g., a network entity) may indicate information to a UE indicating a non-TN (NTN) entity (e.g., a satellite) that may be available for providing services to the UE, and indicating information related to a network energy saving (NES) mode for the network entity.

According to a first proposal, the network entity may indicate, to a UE (e.g., in an RRC_CONNECTED mode), that an NTN entity is available for providing services to the UE, and may indicate a time duration (e.g., a timer) during which the UE may establish a connection with the NTN entity and refrain from connecting with the network entity. That is, the duration limits the UEs ability to reconnect to the TN entity, thereby improving network energy savings of the TN entity. In some cases, the time duration may be based on a duration of the NES mode (e.g., an NES duration), a duration of NTN service availability from the NTN entity, or both.

According to a second proposal, the network entity may signal (e.g., using various techniques) to a UE (e.g., in an IDLE mode) an indication of the NTN entity for the UE to monitor during the NES duration. In some cases, the network entity may transmit the indications of the NTN and the information related to the NES to the UE based at least in part on a traffic demand satisfying a threshold (e.g., being below a threshold), and based at least in part on the NTN entity offering one or more services requested by the UE.

According to both the first proposal and the second proposal, the network entities may communicate information with the NTN entities to support these proposals. For example, the information may include services provided by the NTN entity, positional data (e.g., ephemeris), satellite type, UE information (e.g., requested services, positional data), or any combination thereof.

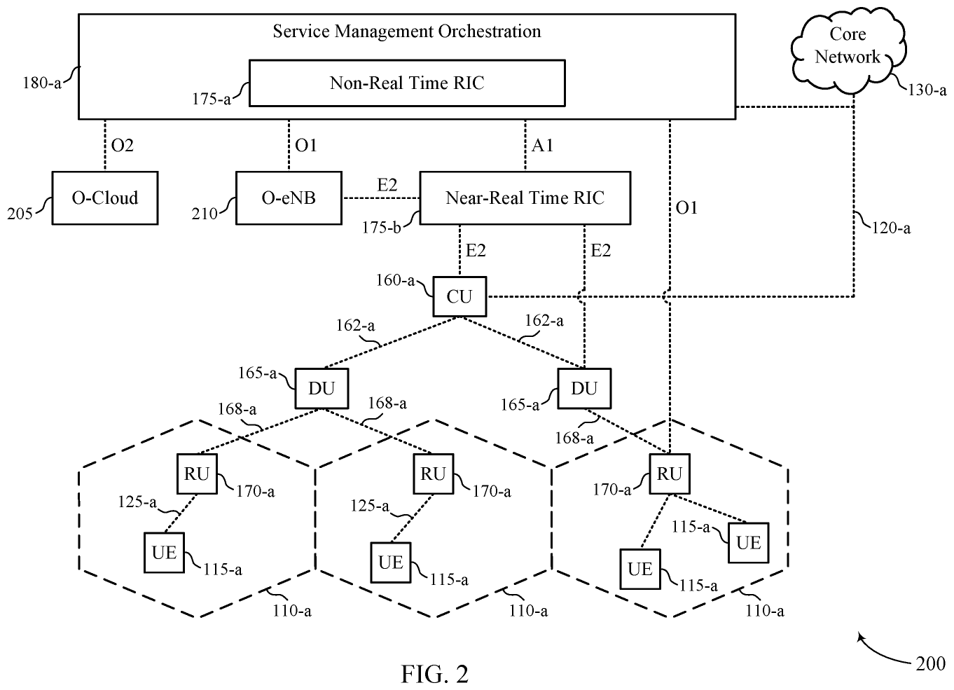

FIG. 2 shows an example of a network architecture 200 (e.g., a disaggregated base station architecture, a disaggregated RAN architecture) that supports network energy savings in terrestrial and NTN coexistence deployment in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In some cases, and according to techniques described herein, network architecture 200 may assist in network energy savings in terrestrial and NTN coexistence deployment. For example, a network entity 105 with the network architecture 200 (e.g., and that is part of a terrestrial network) may indicate information to a UE indicating an NTN entity (e.g., that may be available for providing services to the UE), and indicating information related to an NESs mode for the network entity. Accordingly, the network entity 105 may be able to enter a NES mode while limiting impact of coverage for one or more UEs 115 while the network entity 105 is in the NES mode.

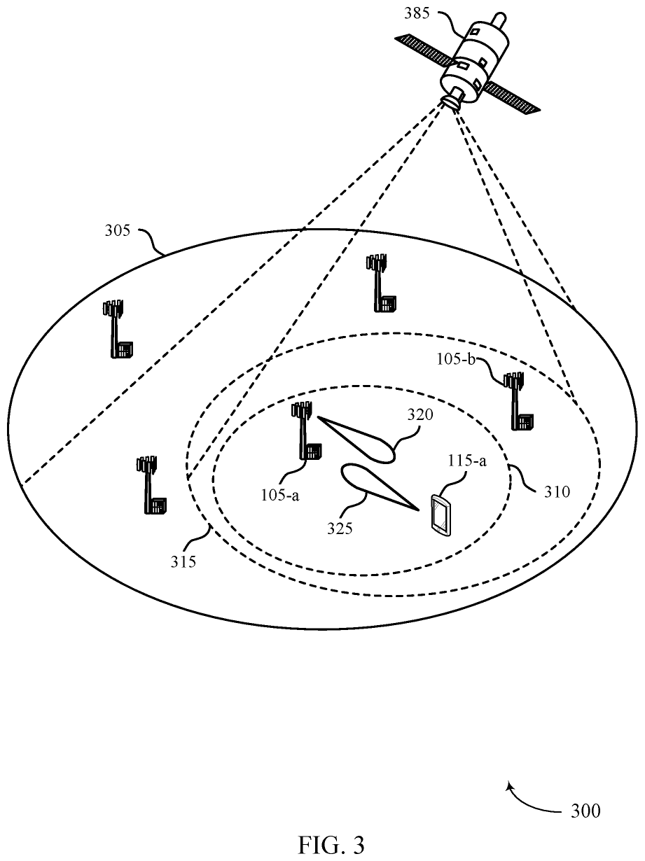

FIG. 3 shows an example of a wireless communications system 300 that supports network energy savings in terrestrial and NTN coexistence deployment in accordance with one or more aspects of the present disclosure. Aspects of the wireless communications system 300 may implement or be implemented by aspects of FIGS. 1 and 2. For example, the wireless communications system 300 may include network entities 105 (e.g., a network entity 105-a, a network entity 105-b) and one or more UEs including a UE 115-a, which may be examples of network entities 105 and UEs 115 as described herein with respect to FIGS. 1 and 2. Additionally, the wireless communications system 300 may include an NTN entity 385, which may be an example of the NTN entity 185 as described herein with reference to FIG. 1, as well as a cell 305 (e.g., an NTN cell 305) and a cell 310 (e.g., a network entity cell 310), which may be examples of the cells as described herein with reference to FIG. 1. In some cases, the network entity 105-a may indicate information about the NTN entity 385 to the UE 115-a, and the information may be associated with or indicative of a NES mode of the network entity 105-a and a service availability duration of the NTN entity 385.

In the illustrated example, the NTN entity 385 is associated with the cell 305, where the NTN entity may provide one or more wireless communications services to entities (e.g., network entities 105, UEs 115) within the cell 305. Further, the network entity 105-a is associated with the cell 310, where the network entity 105-a may provide one or more wireless communications services to UEs 115 within the cell 310 via downlink beams 320, uplink beams 325, or both. Additionally, or alternatively, the network entity 105-a may communicate with the NTN entity 385 (e.g., due to being within the cell 305). Additionally, or alternatively, the NTN entity 385 may provide one or more wireless communications services via an NTN beam 315, and the UE 115-a may establish a communication link (e.g., not shown) with the NTN entity 385.

The wireless communications system 300 may illustrate TN and NTN coexistence. For example, the network entities 105 operating as part of a TN and the NTN entity 385 operating as part of an NTN may share wireless communication loads (e.g., spectrum), which may increase the wireless communication capacity (e.g., resources, bandwidth) of the wireless communications system 300. In some cases, the TN may utilize resources (e.g., bandwidth, a frequency band) adjacent to resources utilized by the NTN. In other cases, the NTN and the TN may utilize the same resources. For example, the same resources may include a 17 GHz frequency and a 27 GHz frequency, a C-band (e.g., 3.7 GHz to 4.2 GHz), a Q/V band (e.g., 37.5-42.5 GHz for the Q-band downlink, and 47.2-52.4 GHz for the V-band uplink), or any combination thereof.

In some cases, the network entities 105 may enter an NES mode (e.g., NES duration). For example, in low traffic load scenarios (e.g., idle, low wireless communications signaling throughput, low traffic demand), the network entity 105-a may enter the NES mode to conserve energy. During the NES mode, the network entity 105-a may reduce synchronization signal block (SSB) transmissions (e.g., reducing an SSB transmission periodicity such that there is more time between SSB transmission) while in the NES mode. In some wireless communications systems, a reduction in SSB transmissions from a network entity may increase latency for access (e.g., initial access) to the network entity by a UE serviced by the network entity. That is, the NES mode by the network entity 105-a may impact latency for initial network access by the UE 115-a

Thus, an NES mode of a first network entity 105 (e.g., the network entity 105-a) may impact UEs 115 served by the first network entity 105 and other network entities 105 (e.g., the network entity 105-b) within neighboring cells. To limit NES mode impacts on UEs 115, the first network entity 105 may handover UEs 115 within the cell of the first network entity 105 to the other network entities 105 before or during the NES mode to increase the energy savings for the first network entity 105. Accordingly, a coordinated NES architecture may be implemented for network entities 105 entering an NES mode. Additionally, and with respect to techniques described herein, a coordinated NES architecture may be applied in the TN and NTN coexistence scenario shown in FIG. 3, where the TN and the NTN may share resources (e.g., spectrum, frequency band) or use different resources, and where TN and NTN coordination may be enabled to support NES mode for the TN entities while limiting or reducing impacts on UEs served by the TN entities.

In some cases, the NES mode of the network entities 105 may comprise a cell discontinuous transmission (DTX) mode, a cell discontinuous reception (DRX) mode, or both. In some examples, network entities 105 (e.g., the network entity 105-a and the network entity 105-b) may coordinate an exchange of inter-node information associated with NES modes for each network entity 105 (e.g., transmitting the inter-node information when neither network entity 105 is in an NES mode). Additionally, the UE 115-a may enter a DTX or DRX mode. In some cases, the network entity 105-a may align the NES mode (e.g., the DTX mode) of the network entity 105-a with the DRX mode of the UE 115-a, such that the network entity 105-a may not transmit signaling while the UE 115-a may not receive the signaling due to the DRX mode. Due at least in part to this alignment of the NES mode of the network entity 105-a and the DRX mode of the UE 115-a, SSB transmissions from the network entity 105-a may not change due to the NES mode.

In some wireless communications systems, it may be desirable to mitigate the impact of an NES mode of a network entity on the UEs serviced by the network entity, where a UE service by the network entity may be in an IDLE (e.g., INACTIVE, disconnected) mode. For example, a discovery or measurement by the UE of the network entity may be impacted by the NES mode, which may negatively impact the operations of the wireless communications system. In some cases, the network entity may transmit downlink reference signals with or without accompanying SSBs, or the network entity may transmit SSBs in response to requests by the UE during the NES mode to avoid such negative impacts.

However, the TN and NTN coexistence scenario (e.g., an area where a TN and an NTN are available to entities), as shown in the wireless communications system 300, may be leveraged to limit impacts of NES modes by TN entities and thereby improve energy savings. According to techniques described herein, an alignment of the NES mode for a network entity 105 (e.g., the network entity 105-a) and NTN coverage by the cell 305 may allow a UE 115 (e.g., the UE 115-a) to receive wireless communications services from the NTN entity 385 during the NES mode. Additionally, the techniques described herein may provide enhancements for the UE 115 (e.g., a UE 115 in an IDLE mode) to perform the discovery or measurements of a network entity 105 (e.g., the network entity 105-a) via the NTN entity 385 during the NES mode.

In some cases, a network entity 105-a and the NTN entity 385 may communicate information associated with performing a handover of a UE 115-a in the cell 310 of the network entity 105-a. As a first example, the network entity 105-a may receive information from the NTN entity (e.g., or the network entity 105-b) indicating attributes of the NTN entity 385. For example, the attributes of the NTN entity 385 may include location information (e.g., an ephemeris), a constellation of the NTN entity 385, a velocity of the NTN entity 385, a type (e.g., satellite type) of the NTN entity 385 (e.g., vLEO-300, LEO-600, LEO-1200, GEO, MEO), a set of one or more wireless communication services offered by the NTN entity 385, or any combination thereof. The network entity 105-a may receive the information indicating the attributes via an access and mobility management function (AMF) (e.g., a core network), or via a backhaul interface between the network entity 105-a and the NTN entity 385.

As another example, the network entity 105-a may transmit information indicating wireless communications traffic conditions to the NTN entity 385. For example, the information may indicate a traffic load to the NTN entity 385, which may include a quantity of UEs 115 (e.g., RRC_CONNECTED UEs 115) within the cell 305, predicted traffic patterns (e.g., typically non-busy duration(s), learned traffic characteristics), whether the quantity of UEs 115 within the cell 305 satisfies (e.g., is under or above) a threshold, or whether a traffic demand from one or more UEs 115 within the cell 305 satisfies (e.g., is under or above) a threshold.

In some cases, the network entity 105-a may determine whether the network entity 105-a is within the cell 305 (e.g., under NTN coverage by the NTN entity 385, has coverage by the NTN entity 385). For example, the network entity 105-a may determine whether the network entity 105-a is within the cell 310 based on a location information (e.g., a nadir point, the point on the Earth's surface that is directly beneath the NTN entity 385, the ephemeris) associated with the NTN entity 385, the type of the NTN entity 385, NTN beamforming by the NTN entity 385, or any combination thereof.

In some cases, the network entity 105-a may determine one or more aspects of the NES mode based on the information exchanged with the NTN entity 385. For example, a DU (e.g., such as the DU 165 as described herein with respect to FIG. 2) of the network entity 105-a may determine one or more configurations of the NES mode, which may include the DTX mode, the DRX mode, or both. In some cases, the configurations of the NES mode may include one or more periodicities, a starting slot, an offset, an on duration (e.g., when the NES mode is activated, an NES duration), or any combination thereof.

In some cases, based on communications between the network entity 105-a and the NTN entity 385, the traffic load experienced by the network entity 105-a, and the attributes of the NTN entity 385, the network entity 105-a (e.g., or a network associated with the network entity 105-a) may determine whether to enter (e.g., be switched to) the NES mode with coordination with the NTN entity 385. For example, and according to techniques described herein, the network entity 105-a may indicate information to a UE 115-a indicating the NTN entity 385 (e.g., that may be available for providing services to the UE 115-a) and information related to the NES mode for the network entity, and the UE 115-a may interact with (e.g., establish a communications link with, monitor communications from) the NTN entity 385.

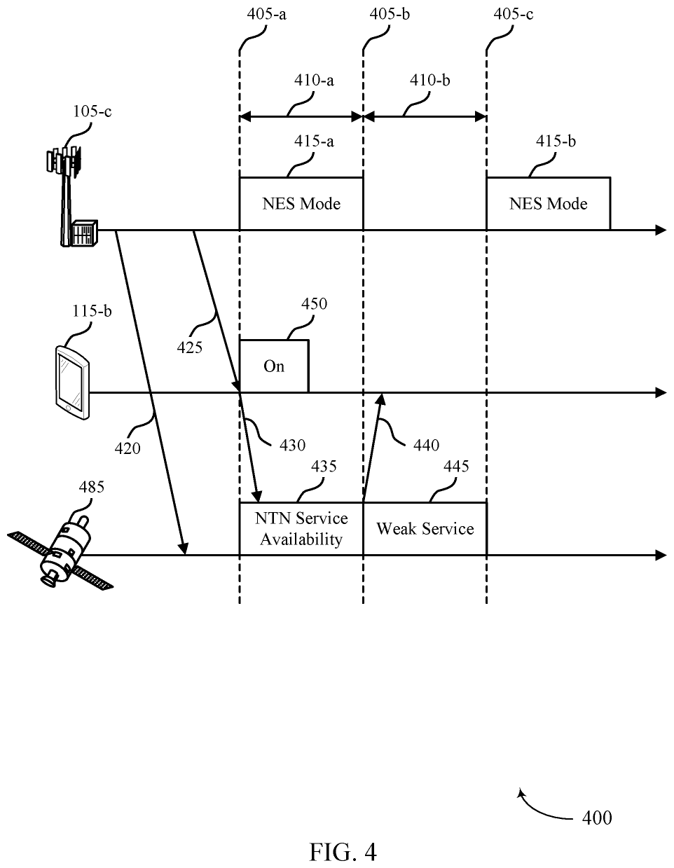

FIG. 4 shows an example of a timing diagram 400 that supports network energy savings in terrestrial and NTN coexistence deployment in accordance with one or more aspects of the present disclosure. Aspects of FIG. 4 may implement or be implemented by aspects of FIGS. 1-3. For example, FIG. 4 may include a network entity 105-c and a UE 115-b, which may be examples of network entities 105 and UEs 115 as described herein with respect to FIGS. 1-3. Additionally, FIG. 4 may include an NTN entity 485, which may be an example of the NTN entity 185 and the NTN entity 385 as described herein with reference to FIGS. 1 and 3, respectively. In some cases, the timing diagram 400 may illustrate interactions between the network entity 105-c, the UE 115-b, and the NTN entity 485 to allow the UE 115-b to establish a communication link with the NTN entity 485 based on (e.g., during) an NES mode 415 of the network entity 105-c.

The timing diagram 400 may include actions taken by and interactions between the network entity 105-c, the UE 115-b, and the NTN entity 485. In some cases, the timing diagram 400 may include a time 405-a, a time 405-b, and a time 405-c, as well as a duration 410-a and a duration 410-b. For example, the timing diagram 400 may illustrate a coordination between the network entity 105-c, the UE 115-b, and NTN entity 485 to allow for the network entity 105-c to enter an NES mode 415-a while mitigating negative impacts (e.g., latency, reduced effect of the NES mode) of the NES mode on the UE 115-b.

In some cases, the network entity 105-c (e.g., or aspects of the network entity 105-c) may configure one or more NES modes 415 (e.g., an NES mode 415-a, and NES mode 415-b). In some cases, the network entity 105-c may configure one or more of the NES modes 415 (e.g., the NES mode 415-a) to align with one or more NTN service availability durations 435. For example, based on attributes associated with the NTN entity 485 (e.g., such as the attributes described herein with reference to FIG. 3), the network entity 105-c may determine that the NTN service availability duration 435 will be during, or overlap with, the duration 410-a. In such an example, the network entity 105-c may configure the NES mode 415-a to occur during the duration 410-a (e.g., aligned with or overlapping with the NTN service availability duration 435). Additionally, or alternatively, the network entity 105-c may compensate for a propagation delay between the NTN entity 485 and the network entity 105-c (e.g., or between the NTN entity 485 and the UE 115-b) by configuring the NES mode 415-a to begin before, or to end after, the duration 410-a. The compensation may be based on the attributes of the NTN entity 485.

In some cases, the network entity 105-c may determine that a traffic load (e.g., a wireless communications signaling throughput associated with the network entity 105-c) satisfies (e.g., is less than) a traffic load threshold. For example, the network entity 105-c may determine that there is a quantity of UEs 115 (e.g., including the UE 115-b) in an RRC_CONNECTED mode within a cell associated with the network entity 105-c, and may determine that the quantity of UEs satisfies (e.g., is less than) a threshold UE quantity. As another example, the network entity 105-c may determine that the services requested by the quantity of UEs (e.g., short message service (SMS), low data traffic) are associated with a traffic load that satisfies the traffic load threshold.

Additionally, or alternatively, the network entity 105-c may request measurements from one or more UEs 115 (e.g., RRC_CONNECTED UEs 115), including the UE 115-b. The one or more UEs 115 may be within a cell associated with the network entity 105-c, and may have NTN capabilities (e.g., a capability to communicate with an NTN entity 485). The measurements may be associated with the NTN entity 485, and the network entity 105-c may use the measurements to determine whether the one or more UEs are or will be within a cell associated with the NTN entity 485 (e.g., NTN coverage) during an NTN service availability duration 435.

Is some cases, the network entity 105-c may transmit signaling 420 to the NTN entity 485 associated with performing a handover of (e.g., offloading) one or more UEs being service by the network entity 105-c, including the UE 115-b. In some cases, the signaling 420 may indicate a quantity of the one or more UEs associated with the handover, services requested by the one or more UEs, other information associated with the one or more UEs, or any combination thereof.

In some cases, the network entity 105-c may transmit (e.g., broadcast) a handover request 425 to the UE 115-b. For example, the handover request 425 may be included in an RRC configuration (e.g., an RRC reconfiguration), and may include information that indicates a time duration (e.g., a timer). In some examples, the indicated time duration may begin at a same time (e.g., in a same slot) as an NES mode 415-a (e.g., an upcoming NES mode, an NES duration), and may last the duration 410-a, the NES mode 415-a, or both. Additionally, or alternatively, the handover request may include an indication as to the cause (e.g., reason) for the handover (e.g., or the handover request 425), where the cause may be to offload one or more UEs 115 (e.g., including the UE 115-b) to an NTN (e.g., the NTN entity 485). In some cases, the network entity 105-c may transmit the handover request 425 at or before the time 405-a, or during the duration 410-a.

In some cases, the network entity 105-c may transmit the handover request 425 based on services requested by the UE 115-b and a set of services offered by the NTN entity 485 (e.g., such as the set of one or more wireless communication services as described herein with respect to FIG. 3). For example, if the services requested by the UE 115-b are not within the set of services offered by the NTN entity 485, the network entity 105-c may not transmit the handover request 425. In some cases, the set of services offered by the NTN entity 485 may not include XR services or other high data rate services.

In some cases, at the time 405-a or during the duration 410-a, the network entity 105-c may enter the NES mode 415-a. Additionally, or alternatively, at the time 405-a, the NTN service availability duration 435 may begin, where the UE 115-b, the network entity 105-c, the cell associated with the network entity 105-c, or any combination thereof, may receive wireless communication services from the NTN entity 485.

Additionally, or alternatively, the UE 115-b may perform a handover 430 at, before, or after the time 405-a. The handover 430 may include establishing a communication link between the UE 115-b and the NTN entity 485. In some cases, the UE 115-b may perform the handover 430 based on one or more services requested by the UE 115-b and a set of services offered by the NTN entity 485 (e.g., such as the set of one or more wireless communication services as described herein with respect to FIG. 3). For example, the handover request 425 may be a conditional handover request, and if the services requested by the UE 115-b are not within the set of services offered by the NTN entity 485, the UE 115-b may not perform the handover 430. If the handover request 425 is a conditional handover request, the network entity 105-c may indicate other additional or alternative conditions for the handover 430.

During at least a portion the duration 410-a, the UE 115-b may enter an on duration 450. For example, the UE 115-b may be associated with a DTX mode, a DRX mode, or both. In some cases, the on duration 450 may represent a DRX on duration, a DTX on duration, or both. Additionally, or alternatively, the on duration 450 may begin before, at, or after the time 405-a, and may occur during at least a portion of the duration 410-a. During the duration 410-a, the UE 115-b may refrain from connecting (e.g., not attempt to connect, skip or refrain from transmitting configured or regular connection requests) to the network entity 105-c based at least in part on the time duration indicated by the handover request 425. As such, the duration may be configured to limit or prevent the UE 115-b from transmitting the connection requests to the network entity 105-c, thereby improving network energy savings at the network entity 105-c.

In some cases, at the time 405-b, the NTN entity 485 may enter a weak service duration 445. In some cases, the weak service duration may last for part or all of the duration 410-b, and may be due to changing attributes (e.g., position) of the NTN entity 485. Additionally, or alternatively, the UE 115-b may perform a handover 440 (or reconnection) from the NTN entity 485 to the network entity 105-c at the time 405-b, where the handover 440 may be based on the time duration. For example, the time duration indicated by the handover request 425 may end at the time 405-b (e.g., based on the NES mode 415-a and the NTN service availability duration 435), and the UE 115-b may perform the handover 440 at the end of the indicated time duration.

In some cases, the UE 115-b may not perform a handover during an NES mode 415. For example, at the time 405-c, the network entity 105-c may enter the NES mode 415-b. At the time 405-c, the UE 115-b may maintain a wireless connection with the network entity 105-c based on an RRC signaling, a configuration message, the handover request 425, or any combination thereof. In some cases, at the time 405-c, the UE 115-b may enter a DTX or DRX of mode based on the NES mode 415-b.

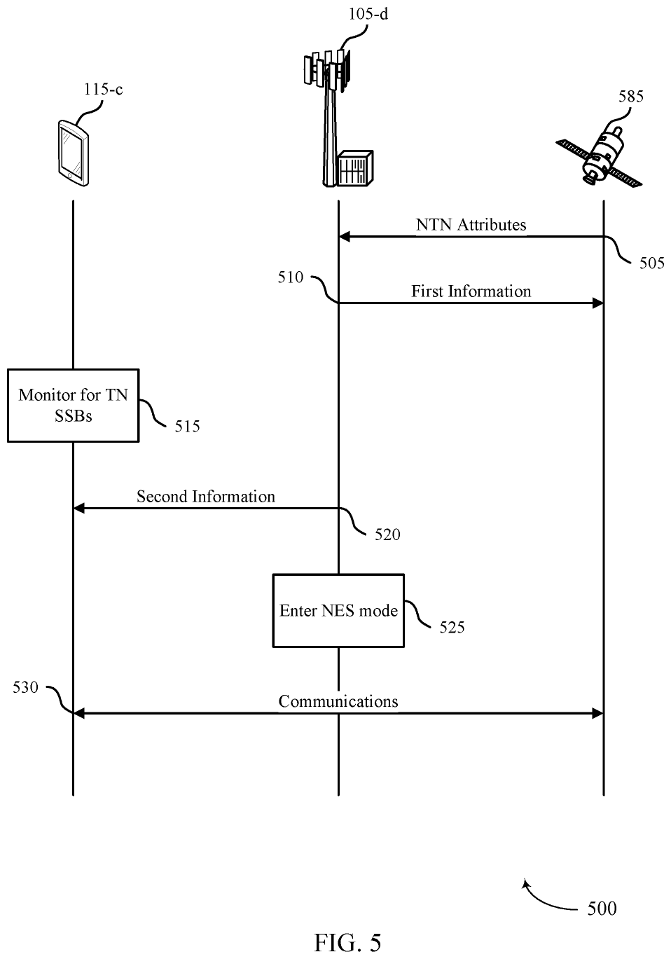

FIG. 5 shows an example of a process flow 500 that supports network energy savings in terrestrial and NTN coexistence deployment in accordance with one or more aspects of the present disclosure. Aspects of the process flow 500 may implement or be implemented by aspects of FIGS. 1-4. For example, the process flow 500 may include a network entity 105-d and a UE 115-c, which may be examples of network entities 105 and UEs 115 as described herein with respect to FIGS. 1-4. Additionally, the process flow 500 may include an NTN entity 385, which may be an example of the NTN entity 185, the NTN entity 385, and the NTN entity 485 as described herein with reference to FIGS. 1, 3, and 4, respectively. In some cases, the process flow 500 may illustrate the network entity 105-d indicating, to the UE 115-c (e.g., a UE in an IDLE mode), information associated with the NTN entity 585 to mitigate negative impacts on the UE 115-c of the network entity 105-d entering an NES mode.

In the following description of process flow 500, the operations may be performed in a different order than the order shown, or other operations may be added or removed from the process flow 500. For example, some operations may also be left out of process flow 500, may be performed in different orders or at different times, or other operations may be added to process flow 500. Although the UE 115-d, the network entity 105-e, and the NTN entity 585 are shown performing the operations of process flow 500, some aspects of some operations may also be performed by one or more other wireless devices or network devices.

In some cases, a network entity may enter an NES mode (e.g., NES duration). The NES mode may be associated with less frequent transmissions (e.g., a low transmission periodicity) for SSBs of system information blocks (SIBs). In some cases, less frequent transmissions of SSBs or SIBs may increase the latency for a UE serviced by the network entity to perform an access (e.g., an initial access) with the network entity, as the UE may perform the access based on one or more SSBs or SIBs from the network entity. Additionally, the power saving effect of the NES mode may be reduced if the network entity in the NES mode transmits the SSBs or SIBs at the same frequency as the network entity not in the NES mode.

In some cases, the UE 115-c may be within a cell (e.g., coverage) associated with the network entity 105-d, and may have NTN capabilities (e.g., the capability to communicate with the NTN entity 585). Additionally, or alternatively, the UE 115-c may be associated with low data rate services, such as SMS, voice over internet protocol (VOIP) services, or other low data rate services. In some cases, the NTN entity 585 may be associated with a set of services offered by the NTN entity 585, where the set of services offered by the NTN entity 585 may include low data rate services.

At 505, the network entity 105-d may communicate, with the NTN entity 585, information associated with communications between the NTN entity 585 and one or more user equipments (e.g., including the UE 115-c). For example, the NTN entity 585 may transmit attributes associated with the NTN entity 585 to the network entity 105-d. In some cases, the attributes may include the attributes described herein with respect to FIG. 3, which may include location information (e.g., an ephemeris) associated with the NTN entity 585, a constellation of the NTN entity 585, a velocity of the NTN entity 585, a type (e.g., satellite type) of the NTN entity 585 (e.g., vLEO-300, LEO-600, LEO-1200, GEO, MEO), the set of services offered by the NTN entity 385, or any combination thereof.

At 510, the network entity 105-d may transmit first information to the NTN entity 585. In some cases, the first information may include a quantity of UEs (e.g., including the UE 115-c) serviced by the network entity 105-d, one or more services requested by the UEs, or other information associated with communications between the NTN entity 585 and the UEs. It should be understood that the NTN attributes communicate between the NTN entity 585 and the network entity 105-d may be referred to as first information herein.

At 515, the UE 115-c may monitor for one or more SSBs transmitted by a network entity (e.g., a TN entity, TN SSBs). In some cases, the UE 115-c may monitor for the SSBs based on being in an IDLE or disconnected mode.

At 520, the UE 115-c may receive, based at least in part on the monitoring of 515, second information that indicates that the NTN entity 585 is available for communications during an NES duration for the network entity 105-d. In some cases, the UE 115-c may receive the second information based on the UE 115-c having NTN capabilities (e.g., the capability to communicate with the NTN entity 585), the UE 115-c being within an NTN coverage, the UE 115-c requesting one or more services compatible with the NTN entity 585 (e.g., SMS, VOIP, low data rate services), or any combination thereof.

In some cases, receiving the second information may include the UE 115-c receiving an information element (IE) comprising the second information that indicates that the NTN entity 585 is available. For example, the UE 115-c may receive the information element as part of a system information (SI) update, where the network entity 105-d may transmit the system information update. In some cases, SI updates are transmitted when a change to SSB transmissions (e.g., change in periodicity) is to occur, and the SI update may include the SI to indicate that the NTN entity 585 is available.

In some cases, receiving the second information may include the UE receiving one or more SSBs (e.g., based on the monitoring of 515) in accordance with a configuration that indicates that the NTN entity 585 is available. For example, the configuration may include at least one of a time offset associated with receiving the one or more SSBs, a periodicity of receipt of the one or more SSBs, a resource in which the one or more SSBs are received, a pattern of receiving the one or more SSBs, or a combination thereof. That is, the pattern of transmissions, the resources used for transmission of the SSBs, the offset of the SSBs, etc. may be individually or collectively indicative of availability of the NTN entity 585.

In some cases, receiving the second information may include the UE receiving control signaling that indicates at least one attribute of the NTN entity 585, where the at least one attribute may indicate that the NTN entity 585 is available. For example, the at least one attribute of the NTN entity 585 may include an NTN availability flag, an ephemeris associated with the NTN entity, or both. In some cases, the control signaling may be an RRC message, a downlink control information (DCI) message, or a MAC layer control element (CE) (MAC-CE) message, and the control signaling may be transmitted by the network entity 105-d.

At 525, the network entity 105-d may transition from a communication mode to an NES mode (e.g., during the NES duration). In some cases, the NES mode may be aligned with an NTN service availability duration associated with the NTN entity 585. In some cases, the network entity 105-d may determine the NTN service availability duration based on the attributes received at 505. Additionally, the network entity 105-d may align the NES mode with the NTN service availability duration based on a propagation delay of communications between the UE 115-c and the NTN entity 585.

At 530, the UE 115-c may communicate with the NTN entity based at least in part on the second information received at 520. For example, the UE 115-c may monitor for one or more SSBs from the NTN entity 585 (e.g., NTN SSBs). In some cases, the UE 115-c may refrain from communicating with (e.g., monitoring) the network entity 105-d during the NES mode of the network entity 105-d. For example, the UE 115-c may refrain from communicating with the network entity 105-d during the NES mode based on a time duration indicated to the UE 115-c in the second information, a known time of the NES mode, or any combination thereof.

These techniques of leveraging the coverage of the NTN entity 585 for NES modes of the network entity 105-d, may provide multiple benefits. For example, these enhancements may avoid terrestrial network cell wake up (e.g., wake of the cell supported by the network entity 105-d), which reduces ping-pong between NES mode and a communication mode (e.g., when the NES mode is off). Additionally, these techniques may reduce search selection for idle UEs, as the signaling indicates that the UEs are to connect to the NTN directly rather than connect to the TN and then switched to the NTN.

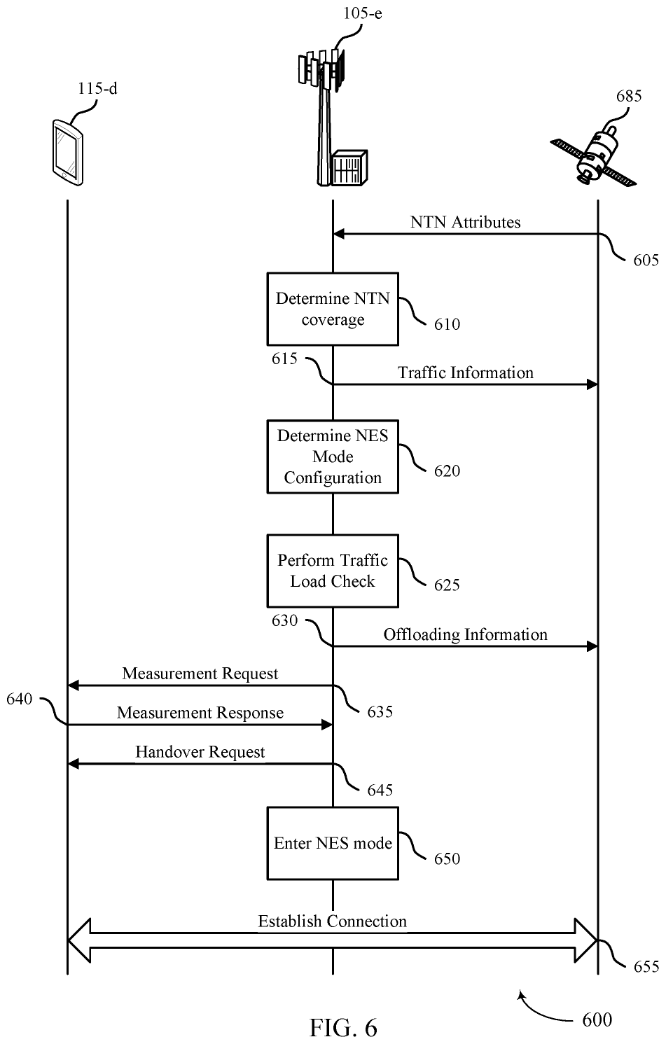

FIG. 6 shows an example of a process flow 600 that supports network energy savings in terrestrial and NTN coexistence deployment in accordance with one or more aspects of the present disclosure. Aspects of the process flow 600 may implement or be implemented by aspects of FIGS. 1-5. For example, the process flow 600 may include a network entity 105-e and a UE 115-d, which may be examples of network entities 105 and UEs 115 as described herein with respect to FIGS. 1-5. Additionally, the process flow 600 may include an NTN entity 685, which may be an example of the NTN entity 185, the NTN entity 385, the NTN entity 485, and the NTN entity 585 as described herein with reference to FIGS. 1, 3, 4, and 5, respectively. In some cases, the process flow 600 may illustrate the network entity 105-e transmitting information to the UE 115-d indicating the NTN entity 685 and a time duration, where the UE 115-d may establish a communication link with the NTN entity 685 based on the information and the time duration.

In the following description of process flow 600, the operations may be performed in a different order than the order shown, or other operations may be added or removed from the process flow 600. For example, some operations may also be left out of process flow 600, may be performed in different orders or at different times, or other operations may be added to process flow 600. Although the UE 115-d, the network entity 105-e, and the NTN entity 685 are shown performing the operations of process flow 600, some aspects of some operations may also be performed by one or more other wireless devices or network devices.

At 605, the network entity 105-e may receive first information that indicates a service availability duration for communications between the UE 115-d and the NTN entity 685, wherein the time duration may be based on the service availability duration. For example, the network entity 105-e may receive, from the NTN entity 685, information indicating one or more attributes of the NTN entity 685 (e.g., such as the attributes of the NTN entity 385 as described herein with reference to FIG. 3). For example, the attributes may include location information (e.g., an ephemeris) associated with the NTN entity 685, a constellation of the NTN entity 685, a velocity of the NTN entity 685, a type (e.g., satellite type) of the NTN entity 685 (e.g., vLEO-300, LEO-600, LEO-1200, GEO, MEO), a set of services offered by the NTN entity 385, or any combination thereof. In some cases, the network entity 105-e may receive the NTN attributes via an AMF (e.g., a core network), or via a backhaul (e.g., Xn) interface between the network entity 105-e and the NTN entity 685.

At 610, the network entity 105-e may determine whether the network entity 105-e is within (e.g., under) an NTN coverage associated with the NTN entity 685. For example, the network entity 105-e may be within the NTN coverage during an NTN service availability duration (e.g., such as the NTN service availability duration 435 as described herein with respect to FIG. 4). In some cases, the network entity 105-e may determine whether the network entity 105-e is within the NTN coverage based at least in part on the location information (e.g., a nadir point) associated with the NTN entity 685, the type of the NTN entity 685, an NTN beamforming of the NTN entity 685, or any combination thereof.

At 615, the network entity 105-e may transmit traffic information to the NTN entity 685. For example, the traffic information may indicate a quantity of UEs 115 (e.g., including the UE 115-d) that are receiving service from the network entity 105-e, a predicted traffic pattern (e.g., a typically low traffic or non-busy duration, learned traffic characteristics), or both.

At 620, the network entity 105-e may determine and NES mode configuration. For example, the network entity 105-e may configure the NES mode to align with an expected or upcoming NTN service availability duration based on the attributes received at 605. The NES mode may include a DTX mode, a DRX mode, or both, where the network entity 105-e may determine a periodicity, a starting slot, an offset (e.g., starting slot offset), an on duration, or any combination thereof, for the NES mode, the DTX mode, the DRX mode, or any combination thereof. Additionally, or alternatively, the NES mode (e.g., NES duration) may be further based at least in part on a propagation delay of communications between the NTN entity 685 and the UE 115-d.

In some cases, based at least in part on the operations at 605, 610, 615, and 620, the network entity 105-e (e.g., or a network associated with the network entity 105-e) may determine whether the network entity 105-e is able to enter the NES mode (e.g., be switched to the NES mode) with coordination between the network entity 105-e, the UE 115-d, and the NTN entity 685.

At 625, the network entity 105-e may perform a traffic load check. For example, the network entity 105-e may determine whether the traffic load (e.g., wireless communications signaling throughput, traffic demand) associated with the network entity 105-e satisfies (e.g., is under) a threshold. As another example, the network entity 105-e may determine that a quantity of UEs 115 being serviced (e.g., in an RRC_CONNECTED mode) by the network entity 105-e satisfies (e.g., is under) a threshold quantity of UEs 115. Additionally, or alternatively, the network entity 105-e may determine that the traffic load includes low data services, which may include SMS and other low data traffic.

At 630, and based on receiving the attributes at 605 and performing the traffic load check at 625, the network entity 105-e may transmit offloading information to the NTN entity 685. For example, the offloading information may indicate the quantity of UEs 115 being serviced by the network entity 105-e, one or more services requested by the one or more UEs 115, or other information associated with the one or more UEs 115.

At 635, the UE 115-d may receive a request to measure one or more signals transmitted by the NTN entity 685. In some cases, the measurement request may be transmitted by the network entity 105-e. Additionally, or alternatively, the measurement request may request that the UE 115-d perform one or more measurements associated with the NTN entity 685, report one or more results of one or more measurements associated with the NTN entity 685, or both.

At 640, the UE 115-d may transmit a measurement report that may indicate a result of measurements of the one or more signals transmitted by the NTN entity 685. In some cases, the network entity 105-e may determine that the UE 115-d is (e.g., or will be) within the NTN coverage based on receiving the measurement response. In some cases, the network entity 105-e may be an anchor cell, the UE 115-d may be in an RRC_CONNECTED mode, the NTN entity 685 may be a non-anchor cell.

At 645, the UE 115-d may receive, from the network entity 105-e, a handover request comprising information that indicates the NTN entity 685 and a time duration during which the UE 115-d may refrain from reconnecting with the network entity 105-e. In some cases, the handover request may be a conditional handover request, as described herein with respect to FIG. 4. The handover request may indicate the NTN entity 685 to the UE 115-d, and may indicate a cause (e.g., reason) for the handover. For example, the cause for the handover may include offloading one or more UEs 115 to an NTN (e.g., to the NTN entity 685). Additionally, or alternatively, the network entity 105-e may transmit the handover request based on the one or more services offered by the NTN entity 685 including one or more services requested by the UE 115-d. In some cases, receiving the handover request may be based on the measurement report transmitted at 640.

Additionally, or alternatively, the handover request may indicate a time duration which may be based on the expected or upcoming NTN service availability duration. For example, the time duration may indicate a start slot and an end slot for the time duration, where the start slot and the end slot correspond to (e.g., align with) a start slot and an end slot of the NTN availability duration, respectively. In some cases, the handover request may indicate for the UE 115-d to establish a connection with the NTN entity 685 before or at the start slot of the time duration.

In some cases, the network entity 105-e may determine (e.g., set) the time duration during a communication duration of the NES mode (e.g., a DTX on duration). For example, the network entity 105-e may transmit, during a communication duration (e.g., a duration of the NES mode where the network entity 105-e does transmit and receive normally) of the NES mode for the terrestrial network entity, an instruction to reset the time duration, where the network entity 105-e may be configured to enter a discontinuous reception cycle, a discontinuous transmission cycle, or both during the time duration.

At 650, the network entity 105-e may enter the NES mode. In some cases, the network entity 105-e may configure the NES mode to align with the NTN service availability duration and the time duration. For example, the network entity 105-e may configure a start slot of the NES mode and the time duration to be a same start slot as the NTN service availability duration based on receiving the attributes at 605.

At 655, the UE 115-d may establish a communication link with the NTN entity 685 based on the handover request. For example, the UE 115-d may establish the connection with the NTN entity 685 on the start slot indicated by the handover request. In some cases, the UE 115-d may establish the connection based on the one or more services offered by the NTN entity 685 including the one or more services requested by the UE 115-d. In some cases, the UE 115-d may refrain from reconnecting to the network entity 105-e after establishing the connection for at least the time duration indicated by the handover request.

In some cases, the UE 115-d may refrain from reconnecting to the network entity 105-e after establishing the connection for at least the time duration indicated by the handover request. In some cases, the UE 115-d may refrain from reconnecting to the network entity 105-e based on the handover request including an indication that the UE 115-d not reconnect to the network entity 105-e during the time duration.

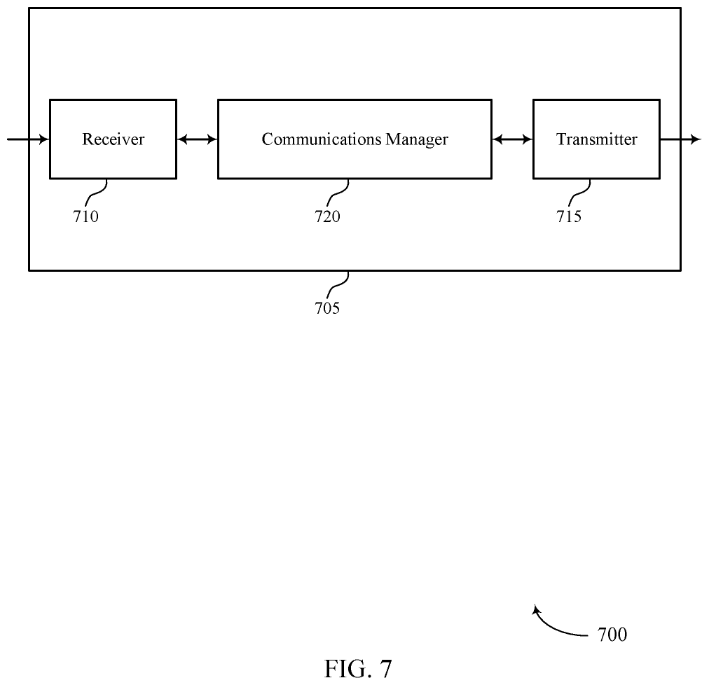

FIG. 7 shows a block diagram 700 of a device 705 that supports network energy savings in terrestrial and NTN coexistence deployment in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to network energy savings in terrestrial and NTN coexistence deployment). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to network energy savings in terrestrial and NTN coexistence deployment). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of network energy savings in terrestrial and NTN coexistence deployment as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. For example, the communications manager 720 is capable of, configured to, or operable to support a means for receiving, from a terrestrial network entity, a handover request including information that indicates an NTN entity and a time duration during which the UE is to refrain from reconnecting with the terrestrial network entity. The communications manager 720 is capable of, configured to, or operable to support a means for establishing a communication link with the NTN entity based on the handover request.

Additionally, or alternatively, the communications manager 720 may support wireless communication in accordance with examples as disclosed herein. For example, the communications manager 720 is capable of, configured to, or operable to support a means for monitoring for one or more SSBs transmitted by a terrestrial network entity. The communications manager 720 is capable of, configured to, or operable to support a means for receiving, based on the monitoring, information that indicates that an NTN entity is available for communications during an NES duration for the terrestrial network entity.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources. For example, the techniques described herein may allow a UE 115 to receive and transmit transmissions more efficiently during an NES mode of a network entity 105, thereby reducing faulty transmission. Thus, the techniques herein may support less wasted communication resources, and therefore more efficient utilization of communication resources.

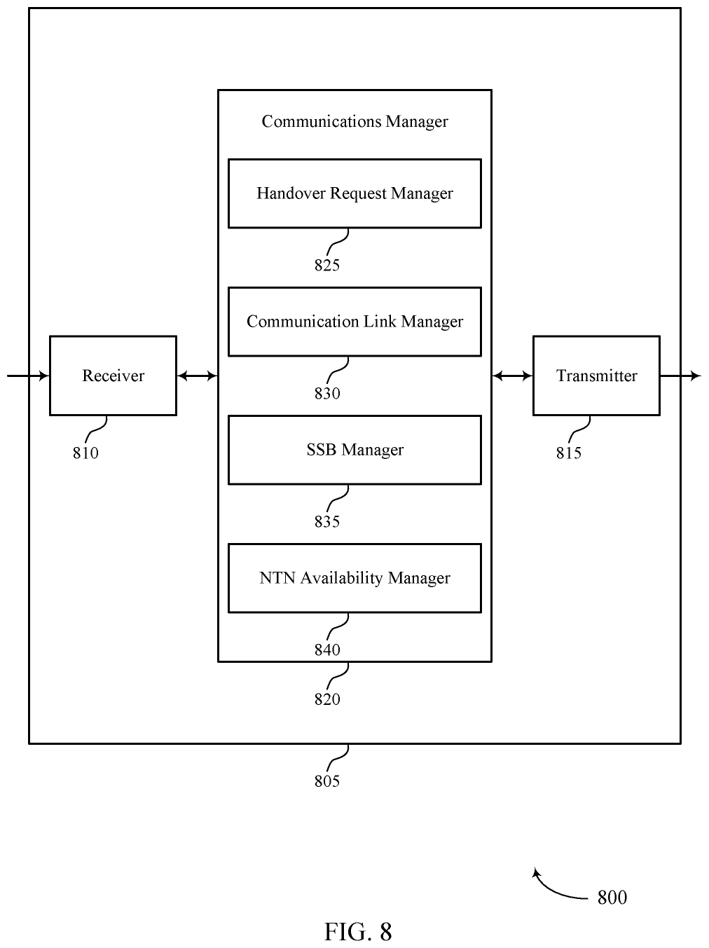

FIG. 8 shows a block diagram 800 of a device 805 that supports network energy savings in terrestrial and NTN coexistence deployment in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to network energy savings in terrestrial and NTN coexistence deployment). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to network energy savings in terrestrial and NTN coexistence deployment). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of network energy savings in terrestrial and NTN coexistence deployment as described herein. For example, the communications manager 820 may include a handover request manager 825, a communication link manager 830, an SSB manager 835, an NTN availability manager 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. The handover request manager 825 is capable of, configured to, or operable to support a means for receiving, from a terrestrial network entity, a handover request including information that indicates an NTN entity and a time duration during which the UE is to refrain from reconnecting with the terrestrial network entity. The communication link manager 830 is capable of, configured to, or operable to support a means for establishing a communication link with the NTN entity based on the handover request.

Additionally, or alternatively, the communications manager 820 may support wireless communication in accordance with examples as disclosed herein. The SSB manager 835 is capable of, configured to, or operable to support a means for monitoring for one or more SSBs transmitted by a terrestrial network entity. The NTN availability manager 840 is capable of, configured to, or operable to support a means for receiving, based on the monitoring, information that indicates that an NTN entity is available for communications during an NES duration for the terrestrial network entity.

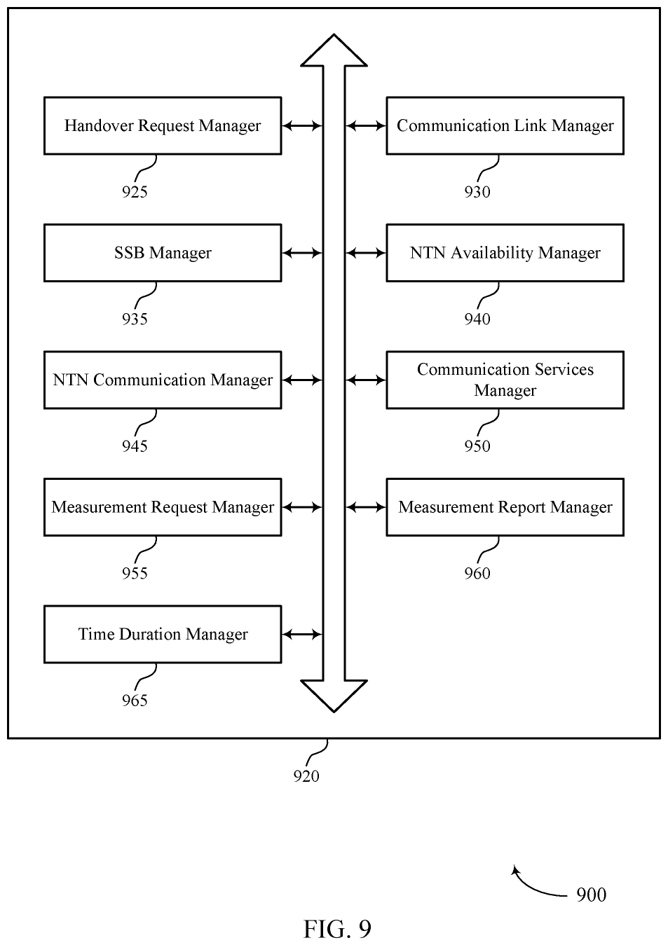

FIG. 9 shows a block diagram 900 of a communications manager 920 that supports network energy savings in terrestrial and NTN coexistence deployment in accordance with one or more aspects of the present disclosure. The communications manager 920 may be an example of aspects of a communications manager 720, a communications manager 820, or both, as described herein. The communications manager 920, or various components thereof, may be an example of means for performing various aspects of network energy savings in terrestrial and NTN coexistence deployment as described herein. For example, the communications manager 920 may include a handover request manager 925, a communication link manager 930, an SSB manager 935, an NTN availability manager 940, an NTN communication manager 945, a communication services manager 950, a measurement request manager 955, a measurement report manager 960, a time duration manager 965, or any combination thereof. Each of these components, or components or subcomponents thereof (e.g., one or more processors, one or more memories), may communicate, directly or indirectly, with one another (e.g., via one or more buses).

The communications manager 920 may support wireless communication in accordance with examples as disclosed herein. The handover request manager 925 is capable of, configured to, or operable to support a means for receiving, from a terrestrial network entity, a handover request including information that indicates an NTN entity and a time duration during which the UE is to refrain from reconnecting with the terrestrial network entity. The communication link manager 930 is capable of, configured to, or operable to support a means for establishing a communication link with the NTN entity based on the handover request.

In some examples, the NTN communication manager 945 is capable of, configured to, or operable to support a means for communicating with the NTN entity over the communication link during the time duration.

In some examples, the time duration is based on a service availability duration associated with the NTN entity, an NES duration associated with the terrestrial network entity, or both the service availability duration and the NES duration.

In some examples, the information indicates a start slot and an end slot corresponding to the time duration.

In some examples, the communication services manager 950 is capable of, configured to, or operable to support a means for transmitting second information that indicates a set of communication services used for communications by the UE, where receiving the handover request includes receiving the handover request based on the set of communication services.

In some examples, the set of communication services includes a data rate, service type, a communication priority, or a combination thereof. In some examples, receiving the handover request includes receiving the handover request based on the NTN entity supporting one or more of the set of communication services.

In some examples, the information indicates that the handover request is configured to offload one or more UEs including the UE to the NTN entity.

In some examples, the measurement request manager 955 is capable of, configured to, or operable to support a means for receiving a request to measure one or more signals transmitted by the NTN entity. In some examples, the measurement report manager 960 is capable of, configured to, or operable to support a means for transmitting a measurement report that indicates a result of measurements of the one or more signals transmitted by the NTN entity, where receiving the handover request includes receiving the handover request based on the measurement report.

In some examples, a duration of a discontinuous reception cycle, a discontinuous transmission cycle, or both, for the terrestrial network entity, is based on a service duration associated with the NTN entity.

In some examples, the time duration manager 965 is capable of, configured to, or operable to support a means for receiving, during a communication duration of an NES mode for the terrestrial network entity, an instruction to reset the time duration.

Additionally, or alternatively, the communications manager 920 may support wireless communication in accordance with examples as disclosed herein. The SSB manager 935 is capable of, configured to, or operable to support a means for monitoring for one or more SSBs transmitted by a terrestrial network entity. The NTN availability manager 940 is capable of, configured to, or operable to support a means for receiving, based on the monitoring, information that indicates that an NTN entity is available for communications during an NES duration for the terrestrial network entity.

In some examples, the NTN communication manager 945 is capable of, configured to, or operable to support a means for communicating with the NTN entity based on the information.

In some examples, to support receiving the information, the NTN availability manager 940 is capable of, configured to, or operable to support a means for receiving, in a system information update, an information element including the information that indicates that the NTN entity is available.

In some examples, to support receiving the information, the NTN availability manager 940 is capable of, configured to, or operable to support a means for receiving the one or more SSBs in accordance with a configuration that indicates that the NTN entity is available.

In some examples, the configuration includes at least one of a time offset associated with receiving the one or more SSBs, a periodicity of receipt of the one or more SSBs, a resource in which the one or more SSBs are received, a pattern of receiving the one or more SSBs, or a combination thereof.

In some examples, to support receiving the information, the NTN availability manager 940 is capable of, configured to, or operable to support a means for receiving control signaling that indicates at least one attribute of the NTN entity, where the at least one attribute indicates that the NTN entity is available.

In some examples, the at least one attribute of the NTN entity includes an NTN availability flag, an ephemeris associated with the NTN entity, or both.

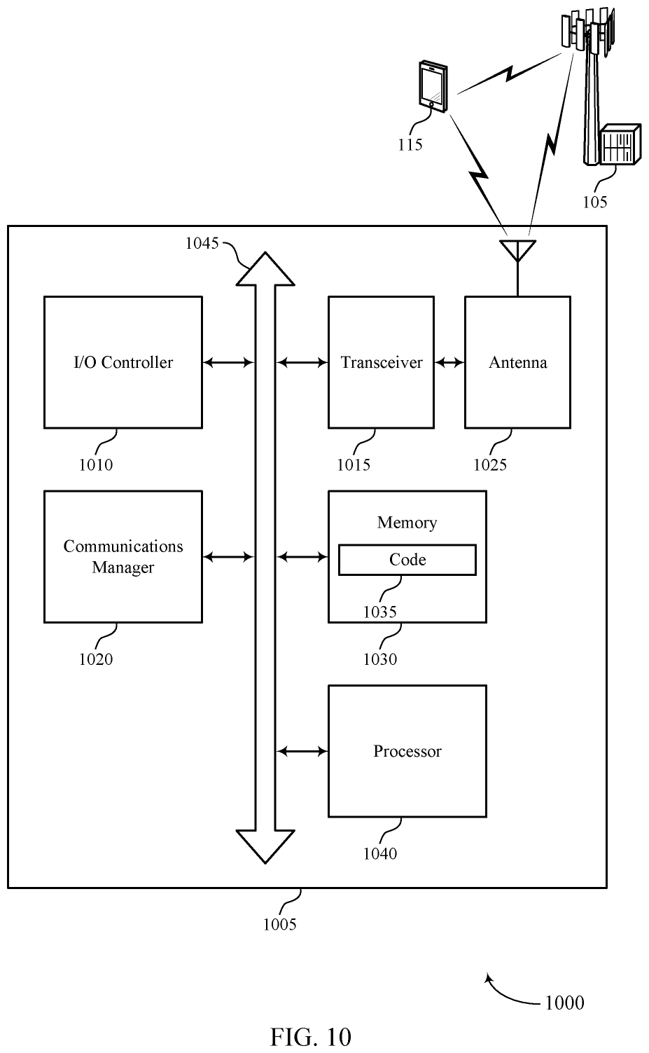

FIG. 10 shows a diagram of a system 1000 including a device 1005 that supports network energy savings in terrestrial and NTN coexistence deployment in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting network energy savings in terrestrial and NTN coexistence deployment). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. As such, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1030 or otherwise, to perform one or more of the functions described herein.

The communications manager 1020 may support wireless communication in accordance with examples as disclosed herein. For example, the communications manager 1020 is capable of, configured to, or operable to support a means for receiving, from a terrestrial network entity, a handover request including information that indicates an NTN entity and a time duration during which the UE is to refrain from reconnecting with the terrestrial network entity. The communications manager 1020 is capable of, configured to, or operable to support a means for establishing a communication link with the NTN entity based on the handover request.

Additionally, or alternatively, the communications manager 1020 may support wireless communication in accordance with examples as disclosed herein. For example, the communications manager 1020 is capable of, configured to, or operable to support a means for monitoring for one or more SSBs transmitted by a terrestrial network entity. The communications manager 1020 is capable of, configured to, or operable to support a means for receiving, based on the monitoring, information that indicates that an NTN entity is available for communications during an NES duration for the terrestrial network entity.

By including or configuring the communications manager 1020 in accordance with examples as described herein, the device 1005 may support techniques for reduced latency. For example, the techniques described herein may allow a UE 115 to communicate with other wireless entities during an NES mode of a network entity 105. Thus, the UE 115 may experience reduced latency in initial connection, normal transmission and reception, or both. Therefore, the techniques described herein support reduced latency at a UE 115.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of network energy savings in terrestrial and NTN coexistence deployment as described herein, or the at least one processor 1040 and the at least one memory 1030 may be otherwise configured to, individually or collectively, perform or support such operations.

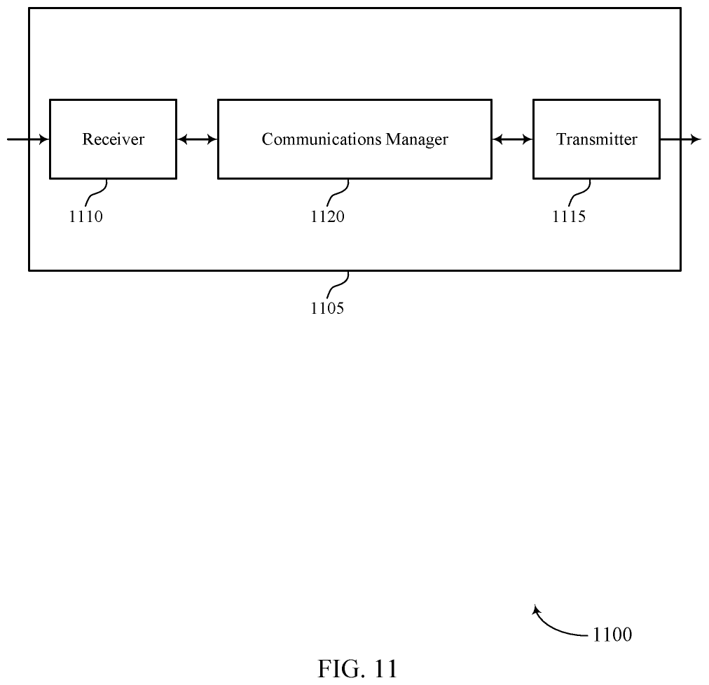

FIG. 11 shows a block diagram 1100 of a device 1105 that supports network energy savings in terrestrial and NTN coexistence deployment in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of network energy savings in terrestrial and NTN coexistence deployment as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. For example, the communications manager 1120 is capable of, configured to, or operable to support a means for communicating, with an NTN entity, first information associating with a handover of one or more UEs serviced by the terrestrial network entity. The communications manager 1120 is capable of, configured to, or operable to support a means for transmitting, to a first UE of the one or more UEs, a handover request including second information that indicates the NTN entity and a time duration during which the first UE is to refrain from reconnecting with the terrestrial network entity.

Additionally, or alternatively, the communications manager 1120 may support wireless communication in accordance with examples as disclosed herein. For example, the communications manager 1120 is capable of, configured to, or operable to support a means for communicating, with an NTN entity, first information associating with communications between the NTN entity and one or more UEs. The communications manager 1120 is capable of, configured to, or operable to support a means for transmitting, to a first UE based on the first information, second information that indicates that the NTN entity is available for communications during an NES duration for the terrestrial network entity.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing and reduced power consumption. For example, the techniques described herein may allow for a network entity 105 to more effectively handover (e.g., offload) UEs 115 serviced by the network entity 105 to an NTN entity during an NES mode of the network entity 105. Thus, during the NES mode, the network entity 105 may experience more energy savings and less processing due to servicing less UEs 115 during the NES mode.

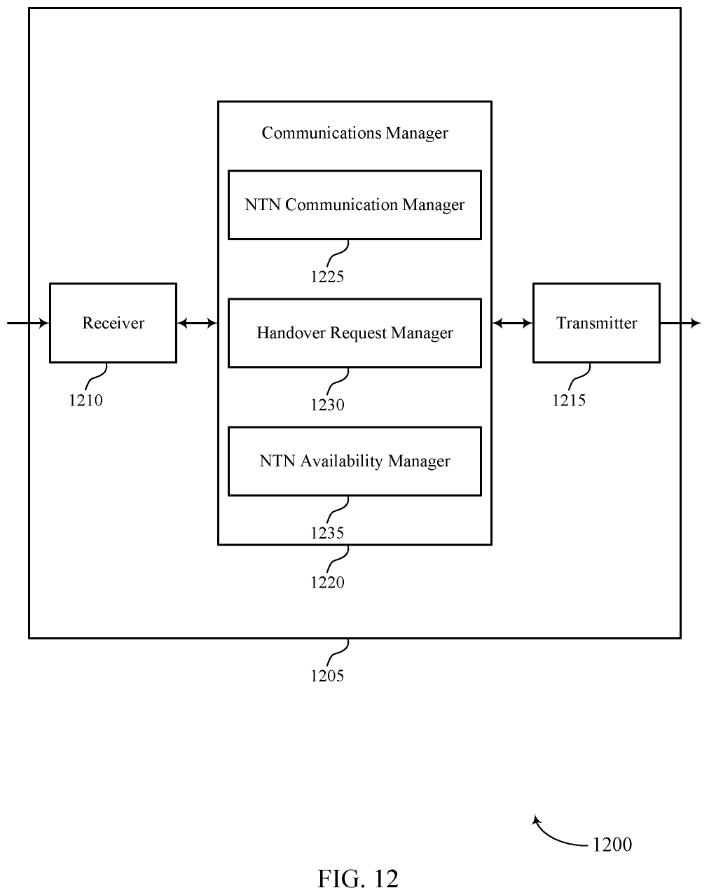

FIG. 12 shows a block diagram 1200 of a device 1205 that supports network energy savings in terrestrial and NTN coexistence deployment in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of network energy savings in terrestrial and NTN coexistence deployment as described herein. For example, the communications manager 1220 may include an NTN communication manager 1225, a handover request manager 1230, an NTN availability manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. The NTN communication manager 1225 is capable of, configured to, or operable to support a means for communicating, with an NTN entity, first information associated with a handover of one or more UEs serviced by the terrestrial network entity. The handover request manager 1230 is capable of, configured to, or operable to support a means for transmitting, to a first UE of the one or more UEs, a handover request including second information that indicates the NTN entity and a time duration during which the first UE is to refrain from reconnecting with the terrestrial network entity.

Additionally, or alternatively, the communications manager 1220 may support wireless communication in accordance with examples as disclosed herein. The NTN communication manager 1225 is capable of, configured to, or operable to support a means for communicating, with an NTN entity, first information associated with communications between the NTN entity and one or more UEs. The NTN availability manager 1235 is capable of, configured to, or operable to support a means for transmitting, to a first UE based on the first information, second information that indicates that the NTN entity is available for communications during an NES duration for the terrestrial network entity.

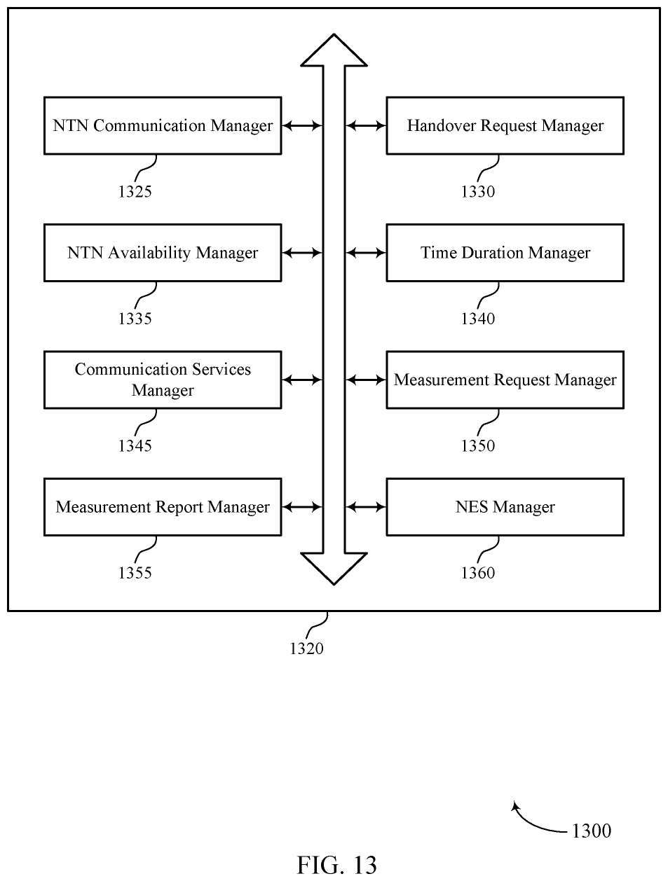

FIG. 13 shows a block diagram 1300 of a communications manager 1320 that supports network energy savings in terrestrial and NTN coexistence deployment in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of network energy savings in terrestrial and NTN coexistence deployment as described herein. For example, the communications manager 1320 may include an NTN communication manager 1325, a handover request manager 1330, an NTN availability manager 1335, a time duration manager 1340, a communication services manager 1345, a measurement request manager 1350, a measurement report manager 1355, an NES manager 1360, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication in accordance with examples as disclosed herein. The NTN communication manager 1325 is capable of, configured to, or operable to support a means for communicating, with an NTN entity, first information associated with a handover of one or more UEs serviced by the terrestrial network entity. The handover request manager 1330 is capable of, configured to, or operable to support a means for transmitting, to a first UE of the one or more UEs, a handover request including second information that indicates the NTN entity and a time duration during which the first UE is to refrain from reconnecting with the terrestrial network entity.

In some examples, the time duration is based on a service availability duration associated with the NTN entity, an NES duration associated with the terrestrial network entity, or both the service availability duration and the NES duration.

In some examples, the second information indicates a start slot and an end slot corresponding to the time duration.

In some examples, to support communicating the first information, the NTN communication manager 1325 is capable of, configured to, or operable to support a means for receiving the first information that indicates a service availability duration for communications between the first UE and the NTN entity, where the time duration is based on the service availability duration.

In some examples, the time duration is further based on a propagation delay of communications between the NTN entity and the first UE.

In some examples, the time duration manager 1340 is capable of, configured to, or operable to support a means for transmitting, during a communication duration of an NES mode for the terrestrial network entity, an instruction to reset the time duration, where the terrestrial network entity is configured to enter a discontinuous reception cycle, a discontinuous transmission cycle, or both during the time duration.

In some examples, the communication services manager 1345 is capable of, configured to, or operable to support a means for receiving, from the first UE, third information that indicates set of communication services used for communications by the first UE, where transmitting the handover request includes transmitting the handover request based on the set of communication services.

In some examples, the set of communication services includes a data rate, service type, a communication priority, or a combination thereof. In some examples, transmitting the handover request includes transmitting the handover request based on receiving, from the NTN entity, an indication that one or more of the set of communication services are supported by the NTN entity.

In some examples, to support transmitting the handover request, the handover request manager 1330 is capable of, configured to, or operable to support a means for transmitting the handover request based on a traffic demand from the one or more UEs serviced by the terrestrial network entity satisfying a threshold.

In some examples, the measurement request manager 1350 is capable of, configured to, or operable to support a means for transmitting a request to measure one or more signals transmitted by the NTN entity. In some examples, the measurement report manager 1355 is capable of, configured to, or operable to support a means for receiving a measurement report that indicates a result of measurements of the one or more signals transmitted by the NTN entity, where transmitting the handover request transmitting the handover request based on the measurement report.

In some examples, to support communicating the first information, the NTN communication manager 1325 is capable of, configured to, or operable to support a means for communicating the first information that indicates attributes associated with the NTN entity, one or more communication service parameters for UEs serviced by the terrestrial network entity, a traffic load for the terrestrial network entity, one or more cell energy saving mode configurations, or a combination thereof, where transmitting the handover request includes transmitting the handover request based on the first information.

Additionally, or alternatively, the communications manager 1320 may support wireless communication in accordance with examples as disclosed herein. In some examples, the NTN communication manager 1325 is capable of, configured to, or operable to support a means for communicating, with an NTN entity, first information associated with communications between the NTN entity and one or more UEs. The NTN availability manager 1335 is capable of, configured to, or operable to support a means for transmitting, to a first UE based on the first information, second information that indicates that the NTN entity is available for communications during an NES duration for the terrestrial network entity.

In some examples, to support transmitting the second information, the NTN availability manager 1335 is capable of, configured to, or operable to support a means for transmitting, in a system information update, an information element including the first information that indicates that the NTN entity is available.

In some examples, to support transmitting the second information, the NTN availability manager 1335 is capable of, configured to, or operable to support a means for transmitting one or more SSBs in accordance with a configuration that indicates that the NTN entity is available.

In some examples, the configuration includes at least one of a time offset associated with receiving the one or more SSBs, a periodicity of receipt of the one or more SSBs, a resource in which the one or more SSBs are received, a pattern of receiving the one or more SSBs, or a combination thereof.

In some examples, to support transmitting the second information, the NTN availability manager 1335 is capable of, configured to, or operable to support a means for transmitting control signaling that indicates at least one attribute of the NTN entity, where the at least one attribute indicates that the NTN entity is available.

In some examples, the at least one attribute of the NTN entity includes an NTN availability flag, an ephemeris associated with the NTN entity, or both.

In some examples, to support transmitting the second information, the NTN availability manager 1335 is capable of, configured to, or operable to support a means for transmitting the second information based on a set of communication services offered by the NTN entity including a communication service requested by the first UE.

In some examples, the NES manager 1360 is capable of, configured to, or operable to support a means for transitioning from a communication mode to an NES mode during the NES duration.

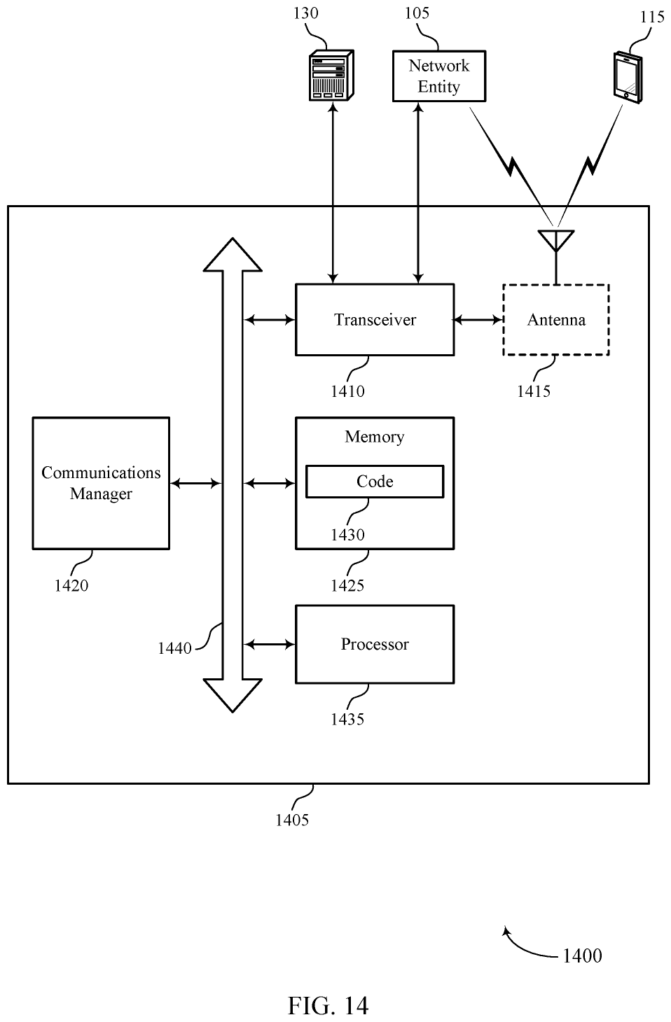

FIG. 14 shows a diagram of a system 1400 including a device 1405 that supports network energy savings in terrestrial and NTN coexistence deployment in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting network energy savings in terrestrial and NTN coexistence deployment). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. As such, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication in accordance with examples as disclosed herein. For example, the communications manager 1420 is capable of, configured to, or operable to support a means for communicating, with an NTN entity, first information associating with a handover of one or more UEs serviced by the terrestrial network entity. The communications manager 1420 is capable of, configured to, or operable to support a means for transmitting, to a first UE of the one or more UEs, a handover request including second information that indicates the NTN entity and a time duration during which the first UE is to refrain from reconnecting with the terrestrial network entity.

Additionally, or alternatively, the communications manager 1420 may support wireless communication in accordance with examples as disclosed herein. For example, the communications manager 1420 is capable of, configured to, or operable to support a means for communicating, with an NTN entity, first information associating with communications between the NTN entity and one or more UEs. The communications manager 1420 is capable of, configured to, or operable to support a means for transmitting, to a first UE based on the first information, second information that indicates that the NTN entity is available for communications during an NES duration for the terrestrial network entity.

By including or configuring the communications manager 1420 in accordance with examples as described herein, the device 1405 may support techniques for improved coordination between devices. For example, the techniques described herein may allow for a network entity 105 to coordinate with UEs 115 and NTN entities to handover (e.g., offload) the UEs 115 to the NTN entities during an NES mode for the network entity 105. Thus, the UEs 115 may receive better service due to improved coordination between the network entity 105, the UEs 115, and the NTN entities.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of network energy savings in terrestrial and NTN coexistence deployment as described herein, or the at least one processor 1435 and the at least one memory 1425 may be otherwise configured to, individually or collectively, perform or support such operations.

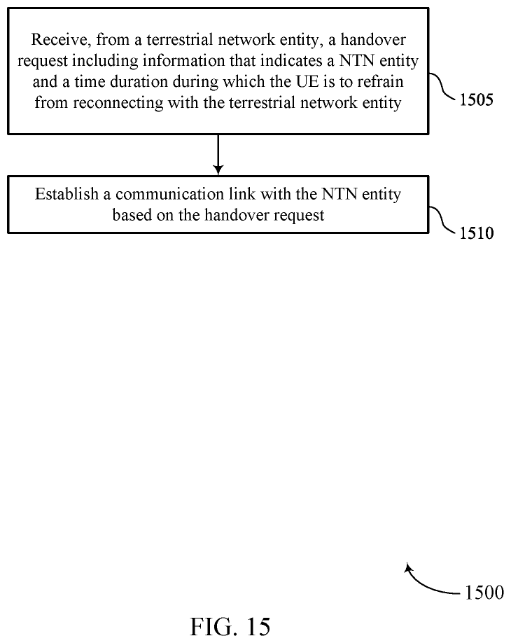

FIG. 15 shows a flowchart illustrating a method 1500 that supports network energy savings in terrestrial and NTN coexistence deployment in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a terrestrial network entity, a handover request including information that indicates an NTN entity and a time duration during which the UE is to refrain from reconnecting with the terrestrial network entity. The operations of block 1505 may be performed in accordance with examples as disclosed herein, such as the handover request at 645 of FIG. 6. In some examples, aspects of the operations of 1505 may be performed by a handover request manager 925 as described with reference to FIG. 9.

At 1510, the method may include establishing a communication link with the NTN entity based on the handover request. The operations of block 1510 may be performed in accordance with examples as disclosed herein, such as between the UE 115-b and the NTN entity 485 of FIG. 4, or the connection established at 655 of FIG. 6. In some examples, aspects of the operations of 1510 may be performed by a communication link manager 930 as described with reference to FIG. 9.

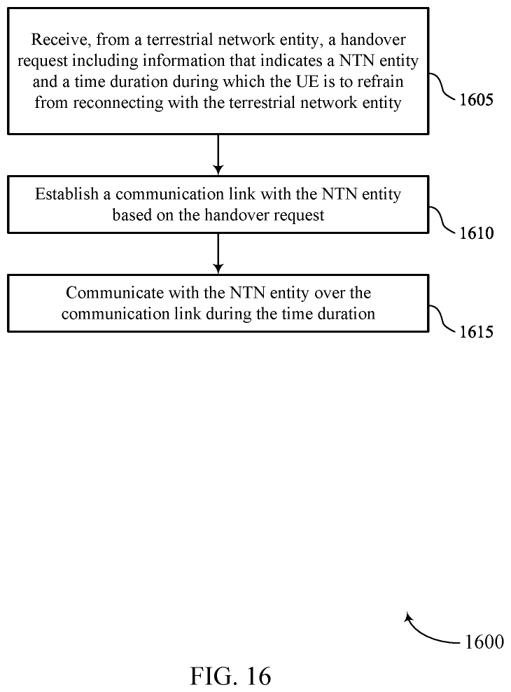

FIG. 16 shows a flowchart illustrating a method 1600 that supports network energy savings in terrestrial and NTN coexistence deployment in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving, from a terrestrial network entity, a handover request including information that indicates an NTN entity and a time duration during which the UE is to refrain from reconnecting with the terrestrial network entity. The operations of block 1605 may be performed in accordance with examples as disclosed herein, such as the handover request at 645 of FIG. 6. In some examples, aspects of the operations of 1605 may be performed by a handover request manager 925 as described with reference to FIG. 9.

At 1610, the method may include establishing a communication link with the NTN entity based on the handover request. The operations of block 1610 may be performed in accordance with examples as disclosed herein, such as between the UE 115-b and the NTN entity 485 of FIG. 4, or the connection established at 655 of FIG. 6. In some examples, aspects of the operations of 1610 may be performed by a communication link manager 930 as described with reference to FIG. 9.

At 1615, the method may include communicating with the NTN entity over the communication link during the time duration. The operations of block 1615 may be performed in accordance with examples as disclosed herein, such as communications over the link established at 655 of FIG. 6. In some examples, aspects of the operations of 1615 may be performed by an NTN communication manager 945 as described with reference to FIG. 9.

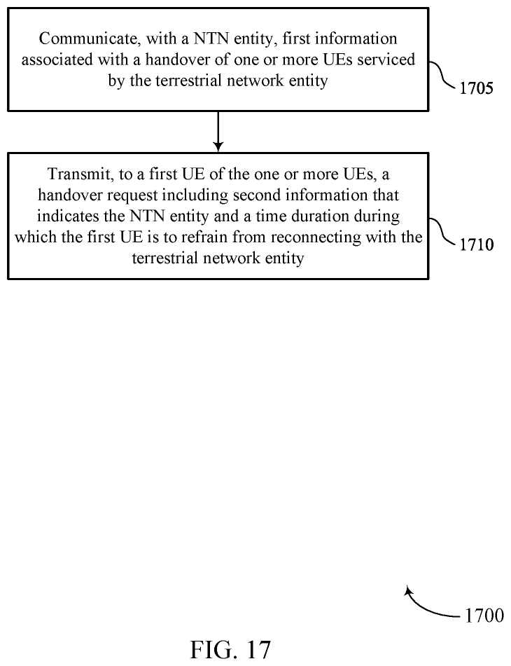

FIG. 17 shows a flowchart illustrating a method 1700 that supports network energy savings in terrestrial and NTN coexistence deployment in accordance with aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include communicating, with an NTN entity, first information associated with a handover of one or more UEs serviced by the terrestrial network entity. The operations of block 1705 may be performed in accordance with examples as disclosed herein, such as the NTN attributes communicated at 605 of FIG. 6, the traffic information communicated at 615 of FIG. 6, and the offloading information communicated at 630 of FIG. 6. In some examples, aspects of the operations of 1705 may be performed by an NTN communication manager 1325 as described with reference to FIG. 13.

At 1710, the method may include transmitting, to a first UE of the one or more UEs, a handover request including second information that indicates the NTN entity and a time duration during which the first UE is to refrain from reconnecting with the terrestrial network entity. The operations of block 1710 may be performed in accordance with examples as disclosed herein, such as transmitting the handover request at 645 of FIG. 6. In some examples, aspects of the operations of 1710 may be performed by a handover request manager 1330 as described with reference to FIG. 13.

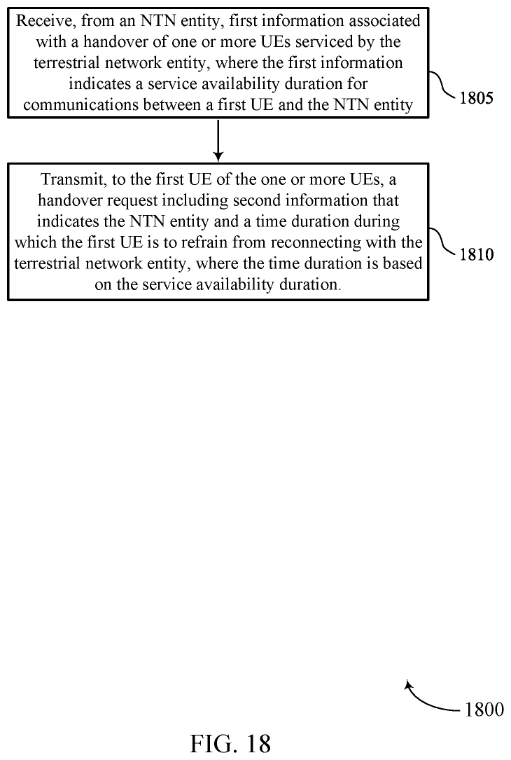

FIG. 18 shows a flowchart illustrating a method 1800 that supports network energy savings in terrestrial and NTN coexistence deployment in accordance with aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include receiving, from an NTN entity, first information associated with a handover of one or more UEs serviced by the terrestrial network entity, where the first information indicates a service availability duration for communications between a first UE and the NTN entity. The operations of block 1805 may be performed in accordance with examples as disclosed herein, such as receiving the NTN attributes at 605 of FIG. 6. In some examples, aspects of the operations of 1805 may be performed by an NTN communication manager 1325 as described with reference to FIG. 13.

At 1810, the method may include transmitting, to the first UE of the one or more UEs, a handover request including second information that indicates the NTN entity and a time duration during which the first UE is to refrain from reconnecting with the terrestrial network entity, where the time duration is based on the service availability duration. The operations of block 1810 may be performed in accordance with examples as disclosed herein, such as transmitting the handover request at 645 of FIG. 6. In some examples, aspects of the operations of 1810 may be performed by a handover request manager 1330 as described with reference to FIG. 13.

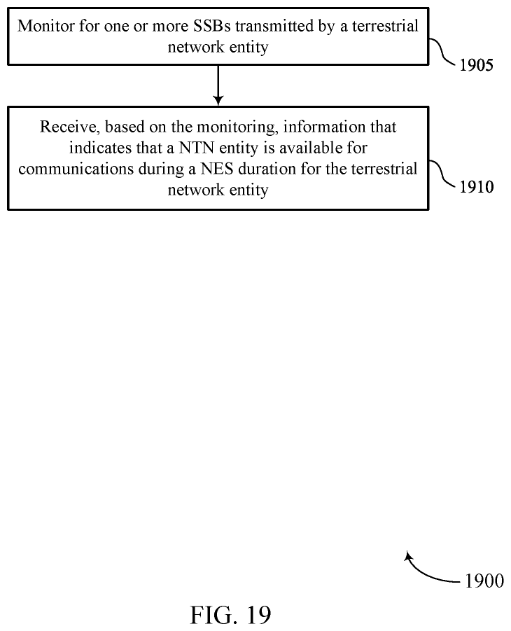

FIG. 19 shows a flowchart illustrating a method 1900 that supports network energy savings in terrestrial and NTN coexistence deployment in accordance with aspects of the present disclosure. The operations of the method 1900 may be implemented by a UE or its components as described herein. For example, the operations of the method 1900 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1905, the method may include monitoring for one or more SSBs transmitted by a terrestrial network entity. The operations of block 1905 may be performed in accordance with examples as disclosed herein, such as the UE 115-c monitoring for TN SSBs at 515 of FIG. 5. In some examples, aspects of the operations of 1905 may be performed by an SSB manager 935 as described with reference to FIG. 9.

At 1910, the method may include receiving, based on the monitoring, information that indicates that an NTN entity is available for communications during an NES duration for the terrestrial network entity. The operations of block 1910 may be performed in accordance with examples as disclosed herein, such as the UE 115-c receiving the second information at 520 of FIG. 5. In some examples, aspects of the operations of 1910 may be performed by an NTN availability manager 940 as described with reference to FIG. 9.

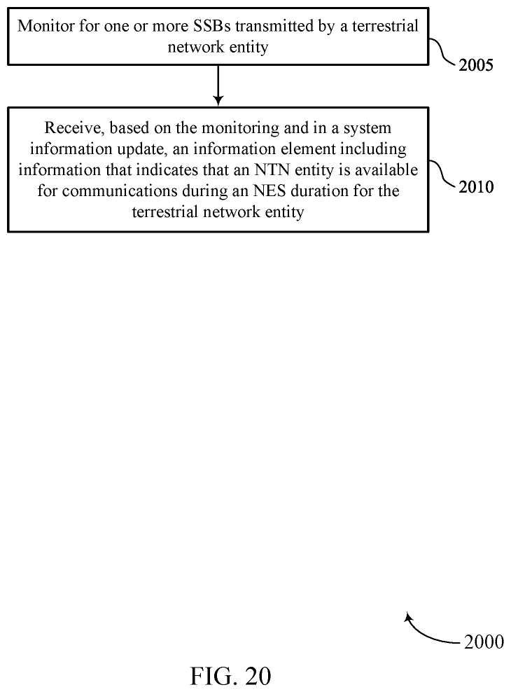

FIG. 20 shows a flowchart illustrating a method 2000 that supports network energy savings in terrestrial and NTN coexistence deployment in accordance with aspects of the present disclosure. The operations of the method 2000 may be implemented by a UE or its components as described herein. For example, the operations of the method 2000 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 2005, the method may include monitoring for one or more SSBs transmitted by a terrestrial network entity. The operations of block 2005 may be performed in accordance with examples as disclosed herein, such as the UE 115-c monitoring for TN SSBs at 515 of FIG. 5. In some examples, aspects of the operations of 2005 may be performed by an SSB manager 935 as described with reference to FIG. 9.

At 2010, the method may include receiving, based on the monitoring and in a system information update, an information element including information that indicates that an NTN entity is available for communications during an NES duration for the terrestrial network entity. The operations of block 2010 may be performed in accordance with examples as disclosed herein, such as the UE 115-c receiving the second information at 520 of FIG. 5. In some examples, aspects of the operations of 2010 may be performed by an NTN availability manager 940 as described with reference to FIG. 9.

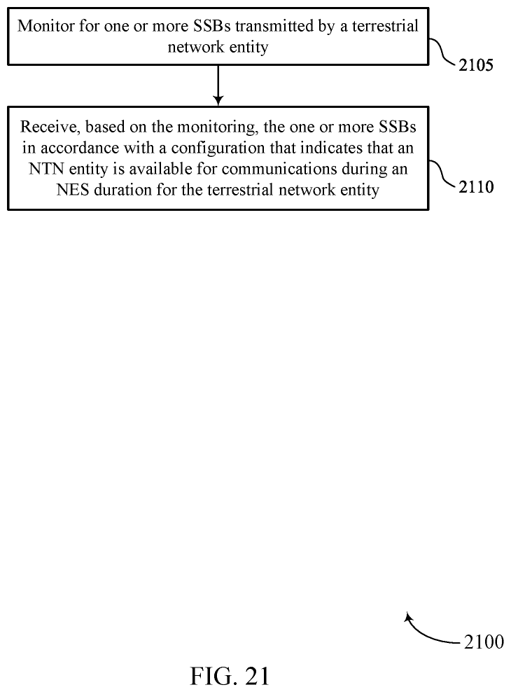

FIG. 21 shows a flowchart illustrating a method 2100 that supports network energy savings in terrestrial and NTN coexistence deployment in accordance with aspects of the present disclosure. The operations of the method 2100 may be implemented by a UE or its components as described herein. For example, the operations of the method 2100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 2105, the method may include monitoring for one or more SSBs transmitted by a terrestrial network entity. The operations of block 2105 may be performed in accordance with examples as disclosed herein, such as the UE 115-c monitoring for TN SSBs at 515 of FIG. 5. In some examples, aspects of the operations of 2105 may be performed by an SSB manager 935 as described with reference to FIG. 9.

At 2110, the method may include receiving, based on the monitoring, based on the monitoring and in a system information update, an information element including information that indicates that an NTN entity is available for communications during an NES duration for the terrestrial network entity. The operations of block 2110 may be performed in accordance with examples as disclosed herein, such as the UE 115-c receiving the second information at 520 of FIG. 5. In some examples, aspects of the operations of 2110 may be performed by an NTN availability manager 940 as described with reference to FIG. 9.

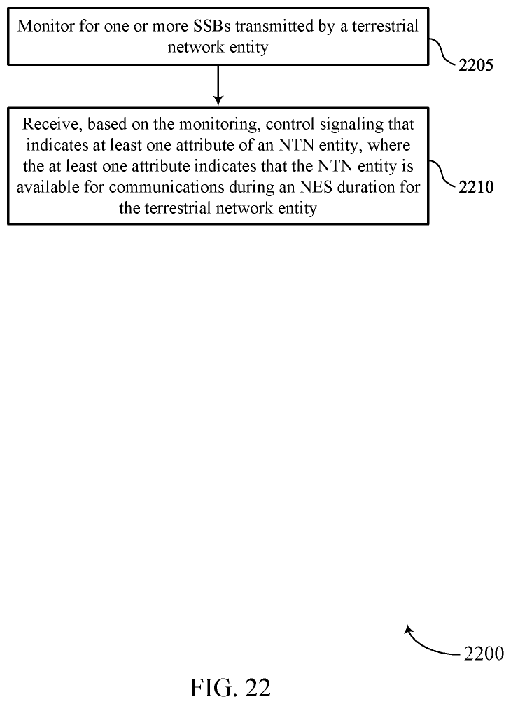

FIG. 22 shows a flowchart illustrating a method 2200 that supports network energy savings in terrestrial and NTN coexistence deployment in accordance with aspects of the present disclosure. The operations of the method 2200 may be implemented by a UE or its components as described herein. For example, the operations of the method 2200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 2205, the method may include monitoring for one or more SSBs transmitted by a terrestrial network entity. The operations of block 2205 may be performed in accordance with examples as disclosed herein, such as the UE 115-c monitoring for TN SSBs at 515 of FIG. 5. In some examples, aspects of the operations of 2205 may be performed by an SSB manager 935 as described with reference to FIG. 9.

At 2210, the method may include receiving, based on the monitoring, control signaling that indicates at least one attribute of an NTN entity, where the at least one attribute indicates that the NTN entity is available for communications during an NES duration for the terrestrial network entity. The operations of block 2210 may be performed in accordance with examples as disclosed herein, such as the UE 115-c receiving the second information at 520 of FIG. 5. In some examples, aspects of the operations of 2210 may be performed by an NTN availability manager 940 as described with reference to FIG. 9.

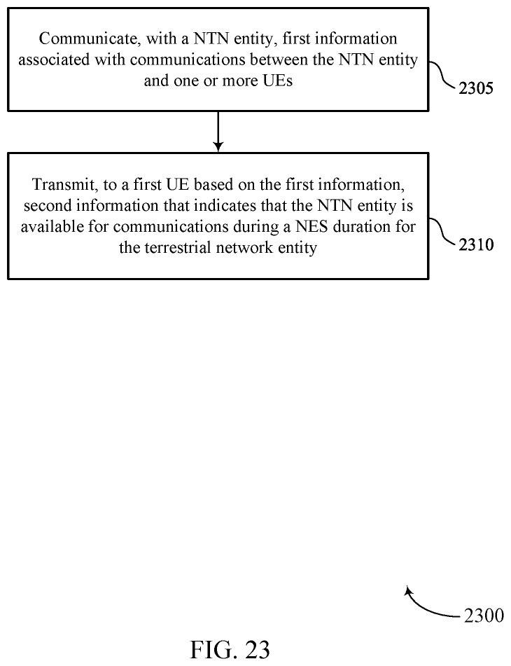

FIG. 23 shows a flowchart illustrating a method 2300 that supports network energy savings in terrestrial and NTN coexistence deployment in accordance with aspects of the present disclosure. The operations of the method 2300 may be implemented by a network entity or its components as described herein. For example, the operations of the method 2300 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2305, the method may include communicating, with an NTN entity, first information associated with communications between the NTN entity and one or more UEs. The operations of block 2305 may be performed in accordance with examples as disclosed herein, such as the NTN attributes communicated at 505 of FIG. 5 and the first information communicated at 510 of FIG. 5. In some examples, aspects of the operations of 2305 may be performed by an NTN communication manager 1325 as described with reference to FIG. 13.

At 2310, the method may include transmitting, to a first UE based on the first information, second information that indicates that the NTN entity is available for communications during an NES duration for the terrestrial network entity. The operations of block 2310 may be performed in accordance with examples as disclosed herein, such as the network entity 105-d transmitting the second information at 520 of FIG. 5. In some examples, aspects of the operations of 2310 may be performed by an NTN availability manager 1335 as described with reference to FIG. 13.

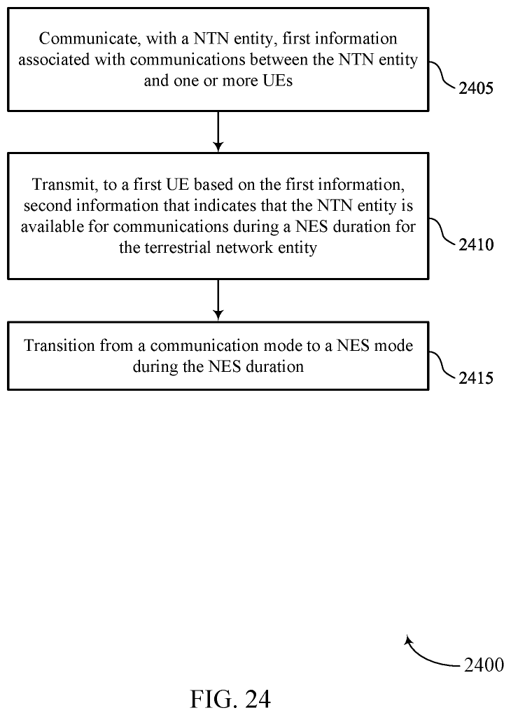

FIG. 24 shows a flowchart illustrating a method 2400 that supports network energy savings in terrestrial and NTN coexistence deployment in accordance with aspects of the present disclosure. The operations of the method 2400 may be implemented by a network entity or its components as described herein. For example, the operations of the method 2400 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2405, the method may include communicating, with an NTN entity, first information associated with communications between the NTN entity and one or more UEs. The operations of block 2405 may be performed in accordance with examples as disclosed herein, such as the NTN attributes communicated at 505 of FIG. 5 and the first information communicated at 510 of FIG. 5. In some examples, aspects of the operations of 2405 may be performed by an NTN communication manager 1325 as described with reference to FIG. 13.

At 2410, the method may include transmitting, to a first UE based on the first information, second information that indicates that the NTN entity is available for communications during an NES duration for the terrestrial network entity. The operations of block 2410 may be performed in accordance with examples as disclosed herein, such as the network entity 105-d transmitting the second information at 520 of FIG. 5. In some examples, aspects of the operations of 2410 may be performed by an NTN availability manager 1335 as described with reference to FIG. 13.

At 2415, the method may include transitioning from a communication mode to an NES mode during the NES duration. The operations of block 2415 may be performed in accordance with examples as disclosed herein, such as the network entity 105-d entering the NES mode at 525 of FIG. 5. In some examples, aspects of the operations of 2415 may be performed by an NES manager 1360 as described with reference to FIG. 13.

Aspect 1: A method for wireless communication at a UE, comprising: receiving, from a TN entity, a handover request comprising information that indicates a NTN entity and a time duration during which the UE is to refrain from reconnecting with the TN entity; and establishing a communication link with the NTN entity based at least in part on the handover request.

Aspect 2: The method of aspect 1, further comprising: communicating with the NTN entity over the communication link during the time duration.

Aspect 3: The method of any of aspects 1 through 2, wherein the time duration is based at least in part on a service availability duration associated with the NTN entity, a network energy saving duration associated with the TN entity, or both the service availability duration and the network energy saving duration.

Aspect 4: The method of aspect 3, wherein the information indicates a start slot and an end slot corresponding to the time duration.

Aspect 5: The method of any of aspects 1 through 4, further comprising: transmitting second information that indicates a set of communication services used for communications by the UE, wherein receiving the handover request comprises receiving the handover request based at least in part on the set of communication services.

Aspect 6: The method of aspect 5, wherein the set of communication services comprises a data rate, service type, a communication priority, or a combination thereof, receiving the handover request comprises receiving the handover request based at least in part on the NTN entity supporting one or more of the set of communication services.

Aspect 7: The method of any of aspects 1 through 6, wherein the information indicates that the handover request is configured to offload one or more UEs comprising the UE to the NTN entity.

Aspect 8: The method of any of aspects 1 through 7, further comprising: receiving a request to measure one or more signals transmitted by the NTN entity; and transmitting a measurement report that indicates a result of measurements of the one or more signals transmitted by the NTN entity, wherein receiving the handover request comprises receiving the handover request based at least in part on the measurement report.

Aspect 9: The method of any of aspects 1 through 8, wherein a duration of a discontinuous reception cycle, a discontinuous transmission cycle, or both, for the TN entity, is based at least in part on a service duration associated with the NTN entity.

Aspect 10: The method of any of aspects 1 through 9, further comprising: receiving, during a communication duration of a network energy saving mode for the TN entity, an instruction to reset the time duration.

Aspect 11: A method for wireless communication at a TN entity, comprising: communicating, with a NTN entity, first information associated with a handover of one or more UEs serviced by the TN entity; and transmitting, to a first UE of the one or more UEs, a handover request comprising second information that indicates the NTN entity and a time duration during which the first UE is to refrain from reconnecting with the TN entity.

Aspect 12: The method of aspect 11, wherein the time duration is based at least in part on a service availability duration associated with the NTN entity, a network energy saving duration associated with the TN entity, or both the service availability duration and the network energy saving duration.

Aspect 13: The method of any of aspects 11 through 12, wherein the second information indicates a start slot and an end slot corresponding to the time duration.

Aspect 14: The method of any of aspects 11 through 13, wherein communicating the first information comprises: receiving the first information that indicates a service availability duration for communications between the first UE and the NTN entity, wherein the time duration is based at least in part on the service availability duration.

Aspect 15: The method of aspect 14, wherein the time duration is further based at least in part on a propagation delay of communications between the NTN entity and the first UE.

Aspect 16: The method of any of aspects 11 through 15, further comprising: transmitting, during a communication duration of a network energy saving mode for the TN entity, an instruction to reset the time duration, wherein the TN entity is configured to enter a discontinuous reception cycle, a discontinuous transmission cycle, or both during the time duration.

Aspect 17: The method of any of aspects 11 through 16, further comprising: receiving, from the first UE, third information that indicates set of communication services used for communications by the first UE, wherein transmitting the handover request comprises transmitting the handover request based at least in part on the set of communication services.

Aspect 18: The method of aspect 17, wherein the set of communication services comprises a data rate, service type, a communication priority, or a combination thereof, transmitting the handover request comprises transmitting the handover request based at least in part on receiving, from the NTN entity, an indication that one or more of the set of communication services are supported by the NTN entity.

Aspect 19: The method of any of aspects 11 through 18, wherein transmitting the handover request comprises: transmitting the handover request based at least in part on a traffic demand from the one or more UEs serviced by the TN entity satisfying a threshold.

Aspect 20: The method of any of aspects 11 through 19, further comprising: transmitting a request to measure one or more signals transmitted by the NTN entity; and receiving a measurement report that indicates a result of measurements of the one or more signals transmitted by the NTN entity, wherein transmitting the handover request transmitting the handover request based at least in part on the measurement report.

Aspect 21: The method of any of aspects 11 through 20, wherein communicating the first information comprises: communicating the first information that indicates attributes associated with the NTN entity, one or more communication service parameters for UEs serviced by the TN entity, a traffic load for the TN entity, one or more cell energy saving mode configurations, or a combination thereof, wherein transmitting the handover request comprises transmitting the handover request based at least in part on the first information.

Aspect 22: A method for wireless communication at a UE, comprising: monitoring for one or more SSBs transmitted by a TN entity; and receiving, based at least in part on the monitoring, information that indicates that a NTN entity is available for communications during a network energy saving duration for the TN entity.

Aspect 23: The method of aspect 22, further comprising: communicating with the NTN entity based at least in part on the information.

Aspect 24: The method of any of aspects 22 through 23, wherein receiving the information comprises: receiving, in a system information update, an information element comprising the information that indicates that the NTN entity is available.

Aspect 25: The method of any of aspects 22 through 24, wherein receiving the information comprises: receiving the one or more SSBs in accordance with a configuration that indicates that the NTN entity is available.

Aspect 26: The method of aspect 25, wherein the configuration comprises at least one of a time offset associated with receiving the one or more SSBs, a periodicity of receipt of the one or more SSBs, a resource in which the one or more SSBs are received, a pattern of receiving the one or more SSBs, or a combination thereof.

Aspect 27: The method of any of aspects 22 through 26, wherein receiving the information comprises: receiving control signaling that indicates at least one attribute of the NTN entity, wherein the at least one attribute indicates that the NTN entity is available.

Aspect 28: The method of aspect 27, wherein the at least one attribute of the NTN entity comprises a NTN availability flag, an ephemeris associated with the NTN entity, or both.

Aspect 29: A method for wireless communication at a TN entity, comprising: communicating, with a NTN entity, first information associated with communications between the NTN entity and one or more UEs; and transmitting, to a first UE based at least in part on the first information, second information that indicates that the NTN entity is available for communications during a network energy saving duration for the TN entity.

Aspect 30: The method of aspect 29, wherein transmitting the second information comprises: transmitting, in a system information update, an information element comprising the first information that indicates that the NTN entity is available.

Aspect 31: The method of any of aspects 29 through 30, wherein transmitting the second information comprises: transmitting one or more SSBs in accordance with a configuration that indicates that the NTN entity is available.

Aspect 32: The method of aspect 31, wherein the configuration comprises at least one of a time offset associated with receiving the one or more SSBs, a periodicity of receipt of the one or more SSBs, a resource in which the one or more SSBs are received, a pattern of receiving the one or more SSBs, or a combination thereof.

Aspect 33: The method of any of aspects 29 through 32, wherein transmitting the second information comprises: transmitting control signaling that indicates at least one attribute of the NTN entity, wherein the at least one attribute indicates that the NTN entity is available.

Aspect 34: The method of aspect 33, wherein the at least one attribute of the NTN entity comprises a NTN availability flag, an ephemeris associated with the NTN entity, or both.

Aspect 35: The method of any of aspects 29 through 34, wherein transmitting the second information comprises: transmitting the second information based at least in part on a set of communication services offered by the NTN entity comprising a communication service requested by the first UE.

Aspect 36: The method of any of aspects 29 through 35, further comprising: transitioning from a communication mode to a network energy saving mode during the network energy saving duration.

Aspect 37: A UE for wireless communication, comprising one or more memories storing processor-executable code, and one or more processors coupled with the one or more memories and individually or collectively operable to execute the code to cause the UE to perform a method of any of aspects 1 through 10.

Aspect 38: A UE for wireless communication, comprising at least one means for performing a method of any of aspects 1 through 10.

Aspect 39: A non-transitory computer-readable medium storing code for wireless communication, the code comprising instructions executable by a processor to perform a method of any of aspects 1 through 10.

Aspect 40: A TN entity for wireless communication, comprising one or more memories storing processor-executable code, and one or more processors coupled with the one or more memories and individually or collectively operable to execute the code to cause the TN entity to perform a method of any of aspects 11 through 21.

Aspect 41: A TN entity for wireless communication, comprising at least one means for performing a method of any of aspects 11 through 21.

Aspect 42: A non-transitory computer-readable medium storing code for wireless communication, the code comprising instructions executable by a processor to perform a method of any of aspects 11 through 21.

Aspect 43: A UE for wireless communication, comprising one or more memories storing processor-executable code, and one or more processors coupled with the one or more memories and individually or collectively operable to execute the code to cause the UE to perform a method of any of aspects 22 through 28.

Aspect 44: A UE for wireless communication, comprising at least one means for performing a method of any of aspects 22 through 28.

Aspect 45: A non-transitory computer-readable medium storing code for wireless communication, the code comprising instructions executable by a processor to perform a method of any of aspects 22 through 28.

Aspect 46: A TN entity for wireless communication, comprising one or more memories storing processor-executable code, and one or more processors coupled with the one or more memories and individually or collectively operable to execute the code to cause the TN entity to perform a method of any of aspects 29 through 36.

Aspect 47: A TN entity for wireless communication, comprising at least one means for performing a method of any of aspects 29 through 36.

Aspect 48: A non-transitory computer-readable medium storing code for wireless communication, the code comprising instructions executable by a processor to perform a method of any of aspects 29 through 36.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more processors;
one or more memories coupled with the one or more processors; and
one or more processor-readable instructions stored in the one or more memories and executable by the one or more processors individually or collectively to cause the apparatus to:
receive, from a terrestrial network entity, a handover request comprising information that indicates a non-terrestrial network entity and a time duration during which the UE is to refrain from reconnecting with the terrestrial network entity; and
establish a communication link with the non-terrestrial network entity based at least in part on the handover request.

2. The apparatus of claim 1, wherein the instructions are further executable by the one or more processors individually or collectively to cause the apparatus to:
communicate with the non-terrestrial network entity over the communication link during the time duration.

3. The apparatus of claim 1, wherein the time duration is based at least in part on a service availability duration associated with the non-terrestrial network entity, a network energy saving duration associated with the terrestrial network entity, or both the service availability duration and the network energy saving duration.

4. The apparatus of claim 1, wherein the instructions are further executable by the one or more processors individually or collectively to cause the apparatus to:
transmit second information that indicates a set of communication services used for communications by the UE, wherein receiving the handover request comprises receiving the handover request based at least in part on the set of communication services.

5. The apparatus of claim 1, wherein the information indicates that the handover request is configured to offload one or more UEs comprising the UE to the non-terrestrial network entity.

6. The apparatus of claim 1, wherein the instructions are further executable by the one or more processors individually or collectively to cause the apparatus to:
receive a request to measure one or more signals transmitted by the non-terrestrial network entity; and
transmit a measurement report that indicates a result of measurements of the one or more signals transmitted by the non-terrestrial network entity, wherein receiving the handover request comprises receiving the handover request based at least in part on the measurement report.

7. The apparatus of claim 1, wherein a duration of a discontinuous reception cycle, a discontinuous transmission cycle, or both, for the terrestrial network entity, is based at least in part on a service duration associated with the non-terrestrial network entity.

8. The apparatus of claim 1, wherein the instructions are further executable by the one or more processors individually or collectively to cause the apparatus to:
receive, during a communication duration of a network energy saving mode for the terrestrial network entity, an instruction to reset the time duration.

9. An apparatus for wireless communication at a terrestrial network entity, comprising:
one or more processors;
one or more memories coupled with the one or more processors; and
one or more processor-readable instructions stored in the one or more memories and executable by the one or more processors individually or collectively to cause the apparatus to:
communicate, with a non-terrestrial network entity, first information associated with a handover of one or more user equipments (UEs) serviced by the terrestrial network entity; and
transmit, to a first UE of the one or more UEs, a handover request comprising second information that indicates the non-terrestrial network entity and a time duration during which the first UE is to refrain from reconnecting with the terrestrial network entity.

10. The apparatus of claim 9, wherein the time duration is based at least in part on a service availability duration associated with the non-terrestrial network entity, a network energy saving duration associated with the terrestrial network entity, or both the service availability duration and the network energy saving duration.

11. The apparatus of claim 9, wherein the instructions to communicate the first information are further executable by the one or more processors individually or collectively to cause the apparatus to:
receive the first information that indicates a service availability duration for communications between the first UE and the non-terrestrial network entity, wherein the time duration is based at least in part on the service availability duration.

12. The apparatus of claim 11, wherein the time duration is further based at least in part on a propagation delay of communications between the non-terrestrial network entity and the first UE.

13. The apparatus of claim 9, wherein the instructions are further executable by the one or more processors individually or collectively to cause the apparatus to:
transmit, during a communication duration of a network energy saving mode for the terrestrial network entity, an instruction to reset the time duration, wherein the terrestrial network entity is configured to enter a discontinuous reception cycle, a discontinuous transmission cycle, or both during the time duration.

14. The apparatus of claim 9, wherein the instructions are further executable by the one or more processors individually or collectively to cause the apparatus to:
receive, from the first UE, third information that indicates set of communication services used for communications by the first UE, wherein transmitting the handover request comprises transmitting the handover request based at least in part on the set of communication services.

15. The apparatus of claim 9, wherein the instructions are further executable by the one or more processors individually or collectively to cause the apparatus to:
transmit a request to measure one or more signals transmitted by the non-terrestrial network entity; and
receive a measurement report that indicates a result of measurements of the one or more signals transmitted by the non-terrestrial network entity, wherein transmitting the handover request transmitting the handover request based at least in part on the measurement report.

16. The apparatus of claim 9, wherein the instructions to communicate the first information are further executable by the one or more processors individually or collectively to cause the apparatus to:
communicate the first information that indicates attributes associated with the non-terrestrial network entity, one or more communication service parameters for UEs serviced by the terrestrial network entity, a traffic load for the terrestrial network entity, one or more cell energy saving mode configurations, or a combination thereof, wherein transmitting the handover request comprises transmitting the handover request based at least in part on the first information.

17. An apparatus for wireless communication at a user equipment (UE), comprising:
one or more processors;
one or more memories coupled with the one or more processors; and
one or more processor-readable instructions stored in the one or more memories and executable by the one or more processors individually or collectively to cause the apparatus to:
monitor for one or more synchronization signal blocks transmitted by a terrestrial network entity; and
receive, based at least in part on the monitoring, information that indicates that a non-terrestrial network entity is available for communications during a network energy saving duration for the terrestrial network entity.

18. The apparatus of claim 17, wherein the instructions are further executable by the one or more processors individually or collectively to cause the apparatus to:
communicate with the non-terrestrial network entity based at least in part on the information.

19. The apparatus of claim 17, wherein the instructions to receive the information are further executable by the one or more processors individually or collectively to cause the apparatus to:
receive, in a system information update, an information element comprising the information that indicates that the non-terrestrial network entity is available.

20. The apparatus of claim 17, wherein the instructions to receive the information are further executable by the one or more processors individually or collectively to cause the apparatus to:
receive the one or more synchronization signal blocks in accordance with a configuration that indicates that the non-terrestrial network entity is available.

21. The apparatus of claim 20, wherein the configuration comprises at least one of a time offset associated with receiving the one or more synchronization signal blocks, a periodicity of receipt of the one or more synchronization signal blocks, a resource in which the one or more synchronization signal blocks are received, a pattern of receiving the one or more synchronization signal blocks, or a combination thereof.

22. The apparatus of claim 17, wherein the instructions to receive the information are further executable by the one or more processors individually or collectively to cause the apparatus to:
receive control signaling that indicates at least one attribute of the non-terrestrial network entity, wherein the at least one attribute indicates that the non-terrestrial network entity is available.

23. The apparatus of claim 22, wherein the at least one attribute of the non-terrestrial network entity comprises a non-terrestrial network availability flag, an ephemeris associated with the non-terrestrial network entity, or both.

24. An apparatus for wireless communication at a terrestrial network entity, comprising:
one or more processors;
one or more memories coupled with the one or more processors; and
one or more processor-readable instructions stored in the one or more memories and executable by the one or more processors individually or collectively to cause the apparatus to:
communicate, with a non-terrestrial network entity, first information associated with communications between the non-terrestrial network entity and one or more user equipments (UEs); and
transmit, to a first UE based at least in part on the first information, second information that indicates that the non-terrestrial network entity is available for communications during a network energy saving duration for the terrestrial network entity.

25. The apparatus of claim 24, wherein the instructions to transmit the second information are further executable by the one or more processors individually or collectively to cause the apparatus to:
transmit, in a system information update, an information element comprising the first information that indicates that the non-terrestrial network entity is available.

26. The apparatus of claim 24, wherein the instructions to transmit the second information are further executable by the one or more processors individually or collectively to cause the apparatus to:
transmit one or more synchronization signal blocks in accordance with a configuration that indicates that the non-terrestrial network entity is available.

27. The apparatus of claim 26, wherein the configuration comprises at least one of a time offset associated with receiving the one or more synchronization signal blocks, a periodicity of receipt of the one or more synchronization signal blocks, a resource in which the one or more synchronization signal blocks are received, a pattern of receiving the one or more synchronization signal blocks, or a combination thereof.

28. The apparatus of claim 24, wherein the instructions to transmit the second information are further executable by the one or more processors individually or collectively to cause the apparatus to:
transmit control signaling that indicates at least one attribute of the non-terrestrial network entity, wherein the at least one attribute indicates that the non-terrestrial network entity is available.

29. The apparatus of claim 28, wherein the at least one attribute of the non-terrestrial network entity comprises a non-terrestrial network availability flag, an ephemeris associated with the non-terrestrial network entity, or both.

30. The apparatus of claim 24, wherein the instructions to transmit the second information are further executable by the one or more processors individually or collectively to cause the apparatus to:
transmit the second information based at least in part on a set of communication services offered by the non-terrestrial network entity comprising a communication service requested by the first UE.
